(19) United States
(12) Patent Application Publication
(10) Pub. No.: US 2026/0046258 A1
(43) Pub. Date: Feb. 12, 2026

(54) PROVIDING ARBITRATION FOR RESOURCE SHARING USING CHANNEL PRIORITY DIFFERENCES IN PROCESSOR-BASED DEVICES

(71) Applicant: Microsoft Technology Licensing, LLC, Redmond, WA (US)

(72) Inventors: Je-Ling HSU, Cary, NC (US); Thomas BASNIGHT, Raleigh, NC (US)

(21) Appl. No.: 18/798,589

(22) Filed: Aug. 8, 2024

(51) Int. Cl. H04L 47/6275

(52) U.S. Cl. CPC H04L 47/6275

(57) ABSTRACT

Providing arbitration for resource sharing using channel priority differences in processor-based devices is disclosed herein. In one exemplary embodiment, a processor-based device comprises a data allocation circuit that is communicatively coupled to one or more ingress channels and one or more egress channels. The data allocation circuit assigns an ingress channel priority to each ingress channel, and assigns an egress channel priority to each egress channel. The data allocation circuit generates one or more channel pairs by iteratively identifying an unpaired egress channel having a highest egress channel priority, calculating absolute differences between each ingress channel priority of each unpaired ingress channel and the egress channel priority of the unpaired egress channel, and allocating the unpaired egress channel to an unpaired ingress channel that corresponds to the smallest absolute difference as a channel pair. The data allocation circuit then performs one or more transactions using the corresponding one or more channel pairs.

### FIELD OF THE DISCLOSURE

The technology of the disclosure relates to usage of shared resources in processor-based devices, and, more particularly, to arbitration for resource sharing among multiple requestors.

### BACKGROUND

Conventional processor-based devices may include a shared resource, such as a memory device, to which access may be sought by multiple requestors (e.g., processes being executed by a processor device, and/or other hardware elements within the processor-based device). To maintain data integrity within the shared resource and ensure smooth operation of the processor-based device, a data allocation circuit of the processor-based device is configured to perform arbitration of the shared resource when multiple requestors seek access to the shared resource. The arbitration mechanism implemented by the data allocation circuit seeks to provide fair and efficient access to the shared resource by the requestors, while avoid conflicts, preventing any single requestor from monopolizing the shared resource, and minimizing access delays.

However, conventional arbitration mechanisms may not be able to provide optimal results across all potential resource sharing scenarios. For example, a data allocation circuit may provide a number of ingress channels via which requests to access a shared resource may be received, as well as a number of egress channels via which the data allocation circuit may forward the requests to the shared resource. In scenarios in which the number of ingress channels exceeds the number of active egress channels, it is desirable for the data allocation circuit to provide fair resource sharing for the incoming traffic requests without starving any requestors. Conversely, in scenarios in which the number of ingress channels is less than or equal to the number of active egress channels, it is desirable for the data allocation circuit to enhance the likelihood of incoming traffic requests being routed to an available egress channel instead of repeatedly attempting to access a busy egress channel.

### SUMMARY

Exemplary embodiments disclosed herein provide arbitration for resource sharing using channel priority differences in processor-based devices. In this regard, in one exemplary embodiment, a processor-based device provides a data allocation circuit that is configured to arbitrate access to a shared resource. The data allocation circuit is communicatively coupled to one or more ingress channels through which requests to access the shared resource may be received, as well as one or more egress channels through which the data allocation circuit may forward the requests to the shared resource. In exemplary operation, the data allocation circuit assigns an ingress channel priority to each ingress channel. In some embodiments, the data allocation circuit may assign each ingress channel priority as a unique value between zero (0) and X−1 inclusive, where X is an integer representing a count of the ingress channels and zero (0) represents a highest ingress channel priority. The data allocation circuit also assigns an egress channel priority to each egress channel. Some embodiments may provide that the data allocation circuit assigns each egress channel priority as a unique value between zero (0) and Y−1 inclusive, where Y is an integer representing a count of the egress channels and zero (0) represents a highest egress channel priority.

The data allocation circuit next generates one or more channel pairs by iteratively performing a series of operations. The data allocation circuit first identifies an unpaired egress channel having a highest egress channel priority, and next calculates one or more absolute differences between the ingress channel priority of each unpaired ingress channel and the egress channel priority of the unpaired egress channel. The data allocation circuit then allocates the unpaired egress channel to the unpaired ingress channel that corresponds to the smallest absolute difference as a channel pair. Once there are either no unpaired ingress channels or no unpaired egress channels remaining, the data allocation circuit performs one or more transactions using the corresponding one or more channel pairs.

According to some embodiments, before arbitrating a next round of requests, the data allocation circuit updates the ingress channel priority of each ingress channel as a remainder of a sum of the ingress channel priority and a count of the transactions, divided by X. The data allocation circuit in such embodiments may also update the egress channel priority of each egress channel as a sum of one (1) and a remainder of a sum of the egress channel priority and the count of the transactions, divided by Y.

Some embodiments may provide that the data allocation circuit organizes the ingress channels and the egress channels into a plurality of groups that each include at least one ingress channel and at least one egress channel. In some such embodiments, the data allocation circuit first assigns, to each group, an individual priority as a unique value between zero (0) and Z−1 inclusive, wherein Z is an integer representing a count of the plurality of groups. The data allocation circuit next determines a group offset as an integer that is larger than a largest count of ingress channels in each group of the plurality of groups, and that can be evenly divided by the largest count of ingress channels in each group of the plurality of groups. The data allocation circuit then assigns, to each group, a group priority as a product of the corresponding individual priority and the group offset.

In some such embodiments that employ groups, the data allocation circuit may identify an unpaired egress channel having a highest egress channel priority among the one or more egress channels by identifying an unpaired egress channel having a highest combination priority of a group priority and the egress channel priority of the egress channel among the one or more egress channels. According to some such embodiments, the data allocation circuit may calculate the one or more absolute differences by calculating one or more absolute differences between a sum of an ingress channel priority of each unpaired ingress channel of the one or more ingress channels and a group priority of each unpaired ingress channel, and a sum of the egress channel priority of the unpaired egress channel and the group priority of the unpaired egress channel. Some such embodiments may provide that each unpaired ingress channel is in a same group as the unpaired egress channel.

Some embodiments that employ groups may further provide that the data allocation circuit updates the individual priority of each group as a remainder of a sum of the individual priority of the group and a count of the one or more transactions, divided by Z. The data allocation circuit may also update the group priority of each group of the plurality of groups as a product of the individual priority of the group and the group offset.

According to some embodiments, the data allocation circuit may further determine whether a target mode condition for an ingress channel of the one or more ingress channels is met. In such embodiments, if the data allocation circuit determines that the target mode condition is met, the data allocation circuit allocates the unpaired egress channel to the ingress channel for which the target mode condition is met as a channel pair, instead of performing the load-balancing operations described herein.

In another exemplary embodiment, a processor-based device comprises a data allocation circuit that is communicatively coupled to one or more ingress channels and one or more egress channels. The data allocation circuit is configured to assign, to each ingress channel of the one or more ingress channels, a corresponding ingress channel priority. The data allocation circuit is further configured to assign, to each egress channel of the one or more egress channels, a corresponding egress channel priority. The data allocation circuit is also configured to generate one or more channel pairs by being configured to iteratively identify an unpaired egress channel having a highest egress channel priority among the one or more egress channels, calculate one or more absolute differences between an ingress channel priority of each unpaired ingress channel of the one or more ingress channels and the egress channel priority of the unpaired egress channel, and allocate the unpaired egress channel to an unpaired ingress channel that corresponds to a smallest absolute difference of the one or more absolute differences as a channel pair. The data allocation circuit is additionally configured to perform one or more transactions using the corresponding one or more channel pairs.

In another exemplary embodiment, a method for providing arbitration for resource sharing using channel priority differences is provided. The method comprises assigning, by a data allocation circuit of a processor-based device, a corresponding ingress channel priority to each ingress channel of one or more ingress channels communicatively coupled to the data allocation circuit. The method further comprises assigning, by the data allocation circuit, a corresponding egress channel priority to each egress channel of one or more egress channels communicatively coupled to the data allocation circuit. The method also comprises generating, by the data allocation circuit, one or more channel pairs by iteratively identifying an unpaired egress channel having a highest egress channel priority among the one or more egress channels, calculating one or more absolute differences between an ingress channel priority of each unpaired ingress channel of the one or more ingress channels and the egress channel priority of the unpaired egress channel, and allocating the unpaired egress channel to an unpaired ingress channel that corresponds to a smallest absolute difference of the one or more absolute differences as a channel pair. The method additionally comprises performing one or more transactions using the corresponding one or more channel pairs.

In another exemplary embodiment, a non-transitory computer-readable medium is provided, the computer-readable medium having stored thereon computer-executable instructions which, when executed by a processor device of a processor-based device, cause the processor device to assign, to each ingress channel of one or more ingress channels, a corresponding ingress channel priority. The computer-executable instructions further cause the processor device to assign, to each egress channel of one or more egress channels, a corresponding egress channel priority. The computer-executable instructions also cause the processor device to generate one or more channel pairs by causing the processor device to iteratively identify an unpaired egress channel having a highest egress channel priority among the one or more egress channels, calculate one or more absolute differences between an ingress channel priority of each unpaired ingress channel of the one or more ingress channels and the egress channel priority of the unpaired egress channel, and allocate the unpaired egress channel to an unpaired ingress channel that corresponds to a smallest absolute difference of the one or more absolute differences as a channel pair. The computer-executable instructions additionally cause the processor device to perform one or more transactions using the corresponding one or more channel pairs.

Those skilled in the art will appreciate the scope of the present disclosure and realize additional embodiments thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several embodiments of the disclosure, and together with the description serve to explain the principles of the disclosure:

FIG. 1 is a block diagram of an exemplary processor-based device that includes a data allocation circuit configured to provide arbitration for resource sharing using channel priority differences;

FIGS. 2A-2D are block diagrams illustrating exemplary resource arbitration by the data allocation circuit of FIG. 1 when operating in a load-balancing mode, according to some embodiments;

FIGS. 3A-3B are block diagrams illustrating exemplary resource arbitration by the data allocation circuit of FIG. 1 when operating in a group-based load-balancing mode using in-group allocation, according to some embodiments;

FIGS. 4A-4B are block diagrams illustrating exemplary resource arbitration by the data allocation circuit of FIG. 1 when operating in a group-based load-balancing mode using cross-group allocation, according to some embodiments;

FIG. 5 is a block diagram illustrating exemplary resource arbitration by the data allocation circuit of FIG. 1 when operating in a target mode, according to some embodiments;

FIGS. 6A-6E provide a flowchart illustrating exemplary operations of the data allocation circuit of FIG. 1 for providing arbitration for resource sharing using channel priority differences, according to some embodiments; and

FIG. 7 is a block diagram of an exemplary processor-based device, such as the processor-based device of FIG. 1, that is configured to provide arbitration for resource sharing using channel priority differences.

### DETAILED DESCRIPTION

Exemplary embodiments disclosed herein provide arbitration for resource sharing using channel priority differences in processor-based devices. In this regard, in one exemplary embodiment, a processor-based device provides a data allocation circuit that is configured to arbitrate access to a shared resource. The data allocation circuit is communicatively coupled to one or more ingress channels through which requests to access the shared resource may be received, as well as one or more egress channels through which the data allocation circuit may forward the requests to the shared resource. In exemplary operation, the data allocation circuit assigns an ingress channel priority to each ingress channel. In some embodiments, the data allocation circuit may assign each ingress channel priority as a unique value between zero (0) and X−1 inclusive, where X is an integer representing a count of the ingress channels and zero (0) represents a highest ingress channel priority. The data allocation circuit also assigns an egress channel priority to each egress channel. Some embodiments may provide that the data allocation circuit assigns each egress channel priority as a unique value between zero (0) and Y−1 inclusive, where Y is an integer representing a count of the egress channels and zero (0) represents a highest egress channel priority.

The data allocation circuit next generates one or more channel pairs by iteratively performing a series of operations. The data allocation circuit first identifies an unpaired egress channel having a highest egress channel priority, and next calculates one or more absolute differences between the ingress channel priority of each unpaired ingress channel and the egress channel priority of the unpaired egress channel. The data allocation circuit then allocates the unpaired egress channel to the unpaired ingress channel that corresponds to the smallest absolute difference as a channel pair. Once there are either no unpaired ingress channels or no unpaired egress channels remaining, the data allocation circuit performs one or more transactions using the corresponding one or more channel pairs.

According to some embodiments, before arbitrating a next round of requests, the data allocation circuit updates the ingress channel priority of each ingress channel as a remainder of a sum of the ingress channel priority and a count of the transactions, divided by X. The data allocation circuit in such embodiments may also update the egress channel priority of each egress channel as a sum of one (1) and a remainder of a sum of the egress channel priority and the count of the transactions, divided by Y.

Some embodiments may provide that the data allocation circuit organizes the ingress channels and the egress channels into a plurality of groups that each include at least one ingress channel and at least one egress channel. In some such embodiments, the data allocation circuit first assigns, to each group, an individual priority as a unique value between zero (0) and Z−1 inclusive, wherein Z is an integer representing a count of the plurality of groups. The data allocation circuit next determines a group offset as an integer that is larger than a largest count of ingress channels in each group of the plurality of groups, and that can be evenly divided by the largest count of ingress channels in each group of the plurality of groups. The data allocation circuit then assigns, to each group, a group priority as a product of the corresponding individual priority and the group offset.

In some such embodiments that employ groups, the data allocation circuit may identify an unpaired egress channel having a highest egress channel priority among the one or more egress channels by identifying an unpaired egress channel having a highest combination priority of a group priority and the egress channel priority of the egress channel among the one or more egress channels. According to some such embodiments, the data allocation circuit may calculate the one or more absolute differences by calculating one or more absolute differences between a sum of an ingress channel priority of each unpaired ingress channel of the one or more ingress channels and a group priority of each unpaired ingress channel, and a sum of the egress channel priority of the unpaired egress channel and the group priority of the unpaired egress channel. Some such embodiments may provide that each unpaired ingress channel is in a same group as the unpaired egress channel.

Some embodiments that employ groups may further provide that the data allocation circuit updates the individual priority of each group as a remainder of a sum of the individual priority of the group and a count of the one or more transactions, divided by Z. The data allocation circuit may also update the group priority of each group of the plurality of groups as a product of the individual priority of the group and the group offset.

According to some embodiments, the data allocation circuit may further determine whether a target mode condition for an ingress channel of the one or more ingress channels is met. In such embodiments, if the data allocation circuit determines that the target mode condition is met, the data allocation circuit allocates the unpaired egress channel to the ingress channel for which the target mode condition is met as a channel pair, instead of performing the load-balancing operations described herein.

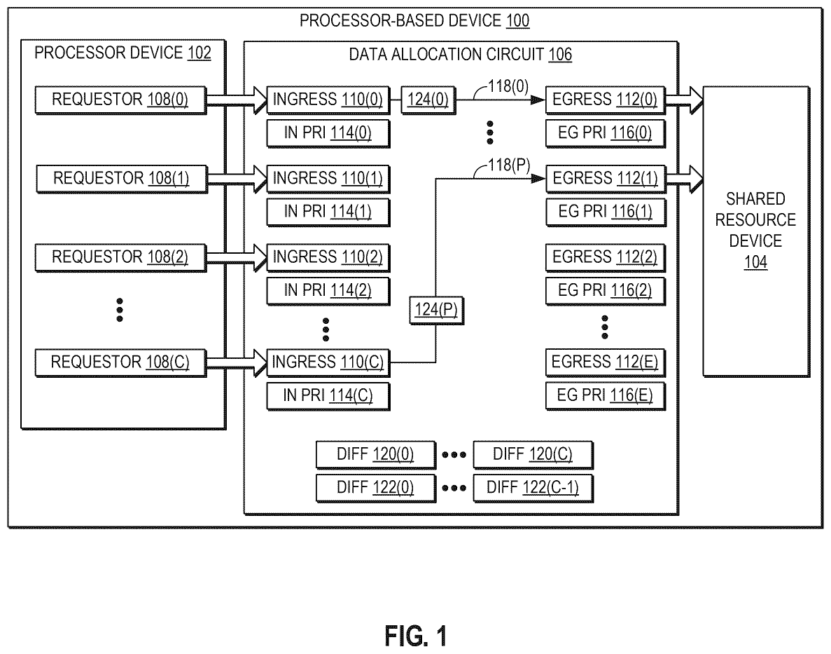

In this regard, FIG. 1 illustrates an exemplary processor-based device 100 that includes a processor device 102. The processor device 102 may comprise one or more processor cores (not shown), each of which may include an instruction processing circuit (not shown) comprising an execution pipeline (not shown) for executing computer instructions. It is to be understood that some embodiments of the processor-based device 100 may comprise multiple processor devices 102 rather than the single processor device 102 shown in the example of FIG. 1, and further that the processor-based device 100 may be one of multiple processor-based devices 100, e.g., organized as a cluster. In some embodiments, the processor-based device 100 may comprise a System-on-Chip (SoC), as a non-limiting example.

As seen in FIG. 1, the processor device 102 is communicatively coupled to a shared resource device 104 via a data allocation circuit 106. The shared resource device 104 may comprise any hardware resource to which access may be arbitrated, and may include, e.g., a memory device such as a Double Data Rate Synchronous Dynamic Random-Access Memory (DDR SDRAM). While the shared resource device 104 is shown in FIG. 1 as an integral element of the processor-based device 100, some embodiments may provide that the shared resource device 104 comprises an external memory device, as a non-limiting example.

The data allocation circuit 106 is configured to arbitrate requests to access the shared resource device 104 from one or more requestors 108(0)-108(C), which may comprise, e.g., processes executing on the processor device 102. To facilitate this functionality, the data allocation circuit 106 is communicatively coupled to one or more ingress channels (captioned as “INGRESS” in FIG. 1) 110(0)-110(C) and one or more egress channels (captioned as “EGRESS” in FIG. 1) 112(0)-112(E). The ingress channels 110(0)-110(C) may comprise hardware ports or interfaces (not shown) through which the data allocation circuit 106 receives requests from the requestors 108(0)-108(C) or may comprise entries in a request queue (not shown) in which requests from the requestors 108(0)-108(C) are queued for processing. The egress channels 112(0)-112(E) may comprise, e.g., ports via which the data allocation circuit 106 may communicate with the shared resource device 104.

The processor-based device 100 of FIG. 1 and the constituent elements thereof may encompass any one of known digital logic elements, semiconductor circuits, processing cores, and/or memory structures, among other elements, or combinations thereof. Embodiments described herein are not restricted to any particular arrangement of elements, and the disclosed techniques may be easily extended to various structures and layouts on semiconductor sockets or packages. It is to be understood that some embodiments of the processor-based device 100 may include elements in addition to those illustrated in FIG. 1. For example, the processor device 102 may further include one or more instruction caches, unified caches, controller circuits, interconnect buses, and/or additional memory devices, caches, and/or controller circuits.

As noted above, the data allocation circuit 106 provides functionality for arbitrating requests from the requestors 108(0)-108(C) to access the shared resource device 104. In scenarios in which the number of ingress channels 110(0)-110(C) exceeds the number of active egress channels 112(0)-112(E), it is desirable for the data allocation circuit 106 to provide fair resource sharing for the incoming traffic requests. Conversely, in scenarios in which the number of ingress channels 110(0)-110(C) is less than or equal to the number of active egress channels 112(0)-112(E), it is desirable for the data allocation circuit 106 to enhance the likelihood of incoming traffic requests being routed to an available egress channel 112(0)-112(E) instead of repeatedly attempting to access a busy egress channel 112(0)-112(E).

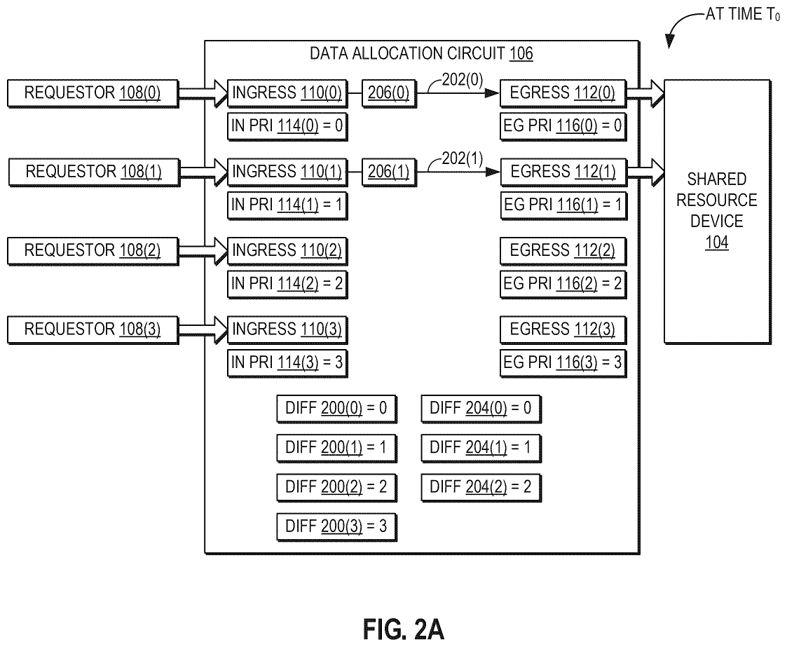

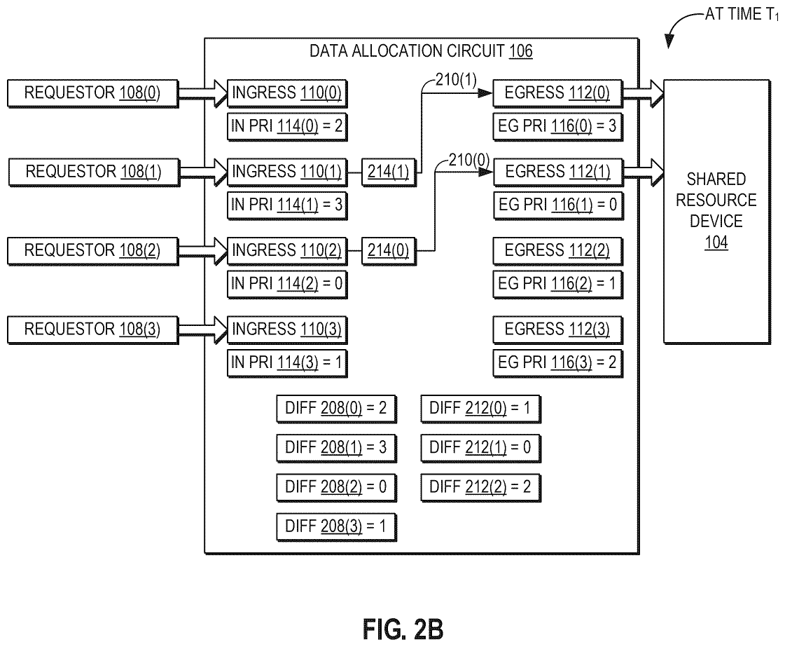

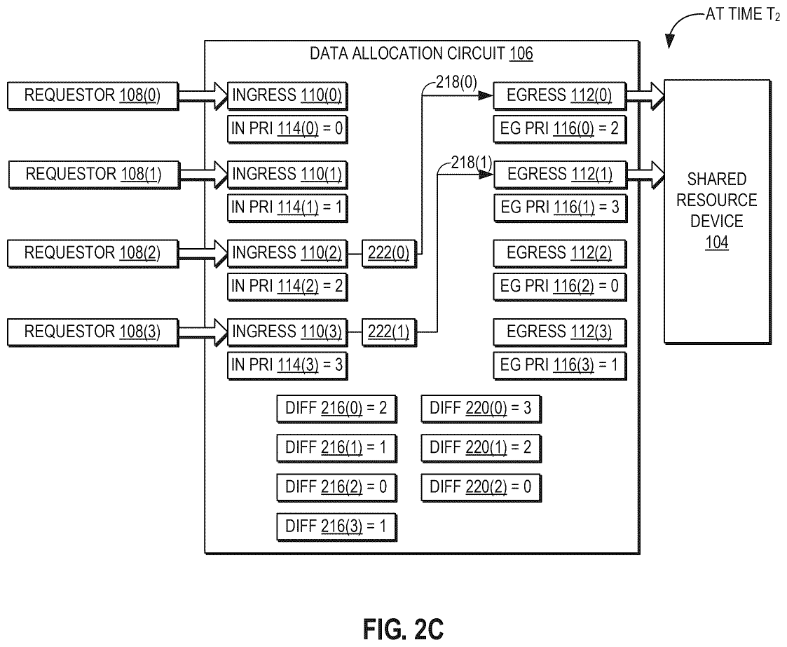

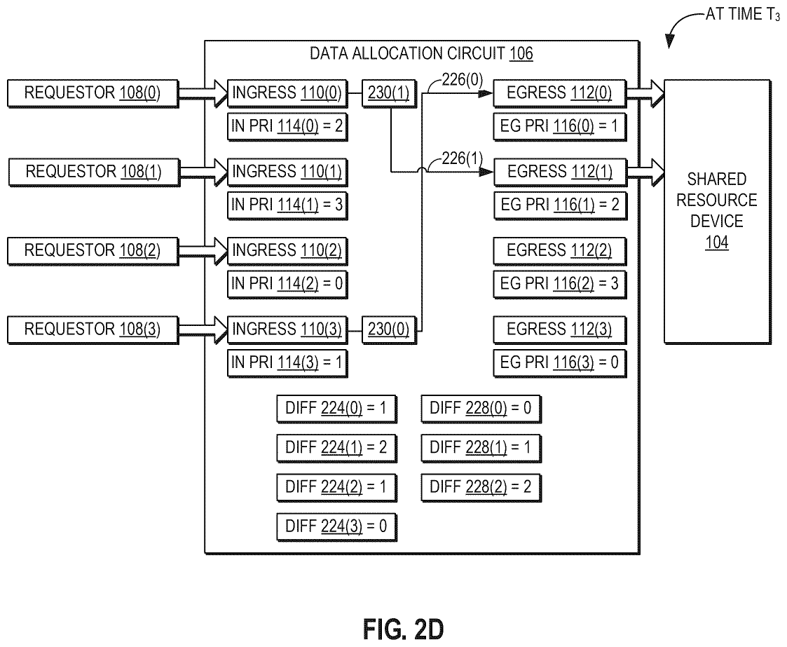

In this regard, the data allocation circuit 106 is configured to provide arbitration for resource sharing using channel priority differences. In the example of FIG. 1, it is assumed that all of the ingress channels 110(0)-110(C) receive inbound requests, while only the egress channels 112(0), 112(1) are available. In exemplary operation, the data allocation circuit 106 assigns a corresponding ingress channel priority (captioned as “IN PRI” in FIG. 1) 114(0)-114(C) to each ingress channel of the one or more ingress channels 110(0)-110(C). The data allocation circuit 106 also assigns a corresponding egress channel priority (captioned as “EG PRI” in FIG. 1) 116(0)-116(E) to each egress channel of the one or more egress channels 112(0)-112(E). Each of the ingress channel priorities 114(0)-114(C) and the egress channel priorities 116(0)-116(E) is an integer value reflecting a relative priority with respect to the other ingress channel priorities 114(0)-114(C) and the egress channel priorities 116(0)-116(E). Exemplary operations for assigning initial values for the ingress channel priorities 114(0)-114(C) and the egress channel priorities 116(0)-116(E) are discussed in greater detail below with respect to FIGS. 2A, 3A, and 4A.

The data allocation circuit 106 next performs a series of operations in iterative fashion to generate one or more channel pairs 118(0)-118(P), each comprising one of the ingress channels 110(0)-110(C) and one of the egress channels 112(0)-112(E). These operations may be repeated, e.g., until there are no more ingress channels 110(0)-110(C) remaining unpaired or no more egress channels 112(0)-112(E) remaining unpaired. The data allocation circuit 106 first identifies an unpaired egress channel having a highest egress channel priority among the egress channel priorities 116(0)-116(E). In this example, it is assumed that egress channel priority 116(0), corresponding to the egress channel 112(0), is the highest among the egress channel priorities 116(0)-116(E), and thus the data allocation circuit 106 selects the egress channel 112(0).

The data allocation circuit 106 next calculates one or more absolute differences (captioned as “DIFF” in FIG. 1) 120(0)-120(C) between the ingress channel priority 114(0)-114(C) of each unpaired ingress channel among the ingress channels 110(0)-110(C) and the egress channel priority 116(0) of the unpaired egress channel 112(0). Thus, for example, if the egress channel priority 116(0) has a value of zero (0) and the ingress channel priorities 114(0)-114(C) have values of zero (0), one (1), two (2) and three (3), respectively, the absolute differences 120(0)-120(C) will have values of zero (0) (i.e., the absolute value of 0-0), one (1) (i.e., the absolute value of 0-1), two (2) (i.e., the absolute value of 0-2), and three (3) (i.e., the absolute value of 0-3), respectively.

The data allocation circuit 106 next allocates the unpaired egress channel 112(0) to an ingress channel that corresponds to the smallest absolute difference among the absolute differences 120(0)-120(C) as the channel pair 118(0). Using the example values above, the data allocation circuit 106 allocates the unpaired egress channel 112(0) to the ingress channel 110(0) corresponding to the smallest absolute difference 120(0) as the channel pair 118(0). Because the ingress channels 110(1)-110(C) and the egress channel 112(1) remain unpaired, the data allocation circuit 106 then repeats another iteration of the operations discussed above. The data allocation circuit 106 identifies the egress channel 112(1) as an unpaired egress channel having a highest egress channel priority 116(1), and calculates one or more absolute differences (captioned as “DIFF” in FIG. 1) 122(0)-122(C-1) between the ingress channel priority 114(1)-114(C) of each unpaired ingress channel among the ingress channels 110(1)-110(C) and the egress channel priority 116(1) of the unpaired egress channel 112(1). The data allocation circuit 106 then allocates the unpaired egress channel 112(1) to an ingress channel (ingress channel 110(C), as an example) that corresponds to the smallest absolute difference among the absolute differences 122(0)-122(C-1) as the channel pair 118(P) (i.e., P=1 in this example).

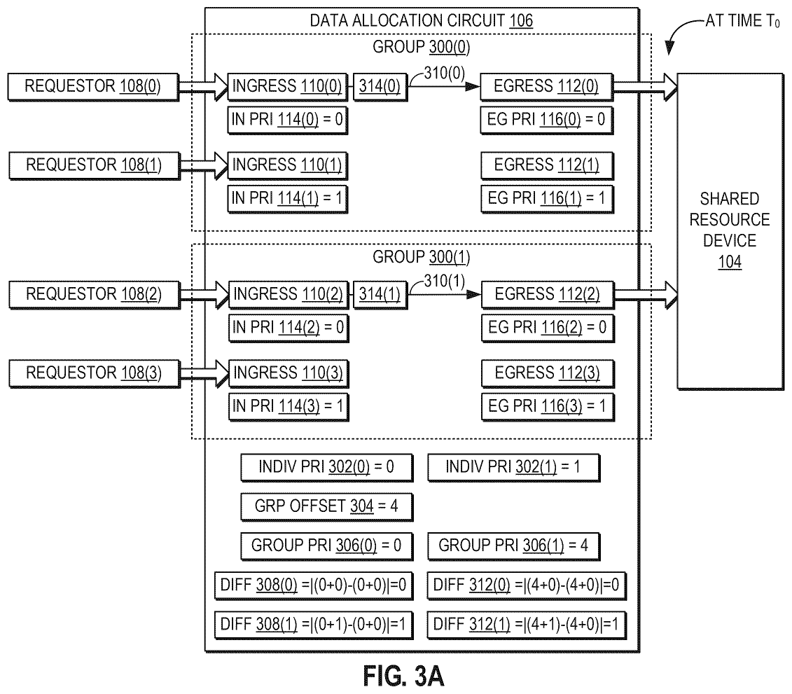

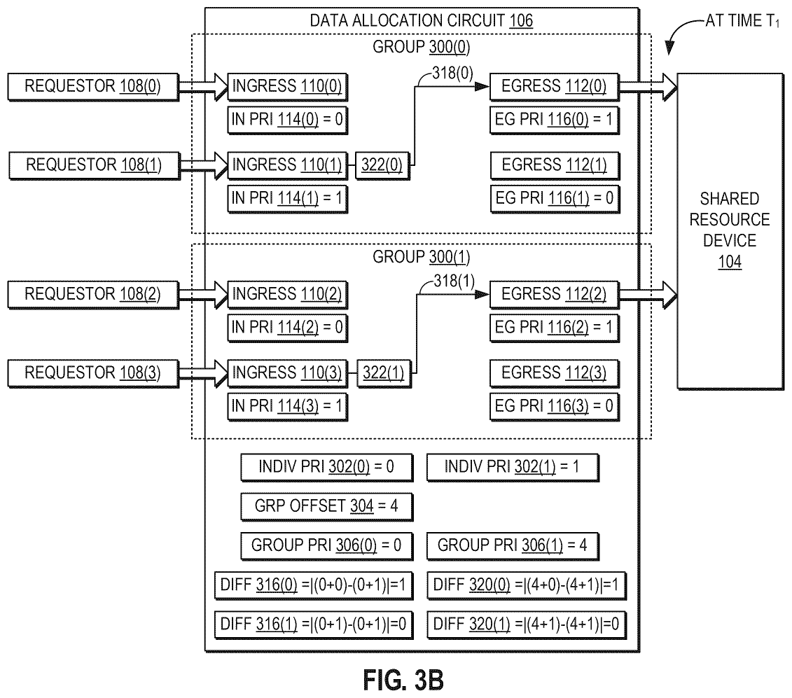

Because no more egress channels 112(0)-112(E) remain unpaired, the data allocation circuit 106 then performs one or more transactions 124(0)-124(P) using the corresponding one or more channel pairs 118(0)-118(P). Performing the transactions 124(0)-124(P) may comprise, e.g., forwarding requests (not shown) received by the data allocation circuit 106 from the requestors 108(0), 108(C) to the shared resource device 104 via the egress channels 112(0), 112(1). After performing the transactions 124(0)-124(P), the data allocation circuit 106 in some embodiments updates the ingress channel priorities 114(0)-114(C) and the egress channel priorities 116(0)-116(E) based on, e.g., the current values of the ingress channel priorities 114(0)-114(C) and the egress channel priorities 116(0)-116(E) and a count of the transactions 124(0)-124(P). Exemplary operations for updating the ingress channel priorities 114(0)-114(C) and the egress channel priorities 116(0)-116(E) are discussed in greater detail below with respect to FIGS. 2B and 3B. After updating the ingress channel priorities 114(0)-114(C) and the egress channel priorities 116(0)-116(E), the data allocation circuit 106 performs another round of generating the channel pairs 118(0)-118(P) to perform further transactions.

The data allocation circuit 106 in some embodiments may perform resource allocation by operating in a load-balancing mode in which available egress channels among the egress channels 112(0)-112(E) of FIG. 1 are fairly shared by the ingress channels 110(0)-110(C). In this regard, FIGS. 2A-2D illustrate exemplary resource arbitration performed by such embodiments of the data allocation circuit 106 of FIG. 1 when operating in a load-balancing mode. In the example of FIGS. 2A-2D, the data allocation circuit 106 of FIG. 1 is shown, along with the ingress channels (captioned as “INGRESS” in FIGS. 2A-2D) 110(0)-110(3) (i.e., C=3 in this example) associated with the requestors 108(0)-108(3) and the egress channels (captioned as “EGRESS” in FIGS. 2A-2D) 112(0)-112(3) (i.e., E=3 in this example) associated with the shared resource device 104. FIGS. 2A-2D also show the ingress channel priorities (captioned as “IN PRI” in FIGS. 2A-2D) 114(0)-114(3) and the egress channel priorities (captioned as “EG PRI” in FIGS. 2A-2D) 116(0)-116(3) of FIG. 1. In the example of FIGS. 2A-2D, the data allocation circuit 106 receives requests from all of the requestors 108(0)-108(3) via the ingress channels 110(0)-110(3), but only the egress channels 112(0), 112(1) are available. Each of FIGS. 2A-2D illustrates an internal state of the data allocation circuit 106 at respective points in time T₀-T₃, which may correspond to, e.g., time intervals or processor clock cycles of the processor device 102 of FIG. 1.

In FIG. 2A, the state of the data allocation circuit 106 at a time T₀ is shown. The data allocation circuit 106 first assigns the ingress channel priorities 114(0)-114(3) to the corresponding ingress channels 110(0)-110(3). In the example of FIGS. 2A-2D, the data allocation circuit 106 assigns each of the ingress channel priorities 114(0)-114(3) as a unique value between zero (0) and X−1 inclusive, wherein X is an integer (four (4), in this example) representing a count of the ingress channels 110(0)-110(3). As seen in FIG. 2A, the ingress channel 110(0) is assigned an initial ingress channel priority 114(0) of zero (0) (i.e., the highest ingress channel priority), while the ingress channels 110(1), 110(2), and 110(3) are assigned initial ingress channel priorities 114(1), 114(2), and 114(3) of one (1), two (2), and three (3), respectively.

The data allocation circuit 106 also assigns the egress channel priorities 116(0)-116(3) to the corresponding egress channels 112(0)-112(3) in similar fashion. Each of the egress channel priorities 116(0)-116(3) is assigned as a unique value between zero (0) and Y−1 inclusive, wherein Y is an integer (four (4), in this example) representing a count of the egress channels 112(0)-112(3). In the example of FIG. 2A, the egress channel 112(0) is assigned an initial egress channel priority 116(0) of zero (0) (i.e., the highest egress channel priority), while the egress channels 112(1), 112(2), and 112(3) are assigned initial egress channel priorities 116(1), 116(2), and 116(3) of one (1), two (2), and three (3), respectively.

The data allocation circuit 106 next iteratively performs a series of operations to generate channel pairs that each associate one of the ingress channels 110(0)-110(3) with a corresponding one of the egress channels 112(0)-112(3). The data allocation circuit 106 may perform the series of operations iteratively until no unpaired ingress channel remain among the available ingress channels 110(0)-110(3) or no unpaired egress channels remain among the available egress channels 112(0), 112(1). The data allocation circuit 106 begins the series of operations by first identifying an unpaired egress channel among the egress channels 112(0), 112(1) that has a highest egress channel priority 116(0), 116(1). In the example of FIG. 2A, the egress channel 112(0) is the unpaired egress channel with the highest egress channel priority 116(0) of zero (0).

The data allocation circuit 106 then calculates a plurality of absolute differences (captioned as “DIFF” in FIG. 2A) 200(0)-200(3) between each of the ingress channel priorities 114(0)-114(3) of the unpaired ingress channels 110(0)-110(3) (i.e., zero (0), one (1), two (2), and three (3), respectively) and the egress channel priority 116(0) (i.e., zero (0)). As seen in FIG. 2A, the absolute difference 200(0) is zero (0) (i.e., the absolute value of 0-0); the absolute difference 200(1) is one (1) (i.e., the absolute value of 1-0); the absolute difference 200(2) is two (2) (i.e., the absolute value of 2-0); and the absolute difference 200(3) is three (3) (i.e., the absolute value of 3-0).

The data allocation circuit 106 next allocates the egress channel 112(0) to the unpaired ingress channel 110(0)-110(3) that corresponds to the smallest absolute difference 200(0)-200(3). In FIG. 2A, the smallest absolute difference 200(0)-200(3) is the absolute difference 200(0) with a value of zero (0). The absolute difference 200(0) in turn corresponds to the ingress channel 110(0). Thus, the data allocation circuit 106 allocates the egress channel 112(0) to the ingress channel 110(0) as a channel pair 202(0).

Because both the ingress channels 110(1)-110(3) and the egress channel 112(1) remain unpaired, the data allocation circuit 106 performs the series of operations again. The data allocation circuit 106 identifies the unpaired egress channel 112(1), having the egress channel priority 116(1) of one (1), as the only remaining unpaired egress channel. The data allocation circuit 106 next calculates a plurality of absolute differences (captioned as “DIFF” in FIG. 2A) 204(0)-204(2) between each of the ingress channel priorities 114(1)-114(3) of the unpaired ingress channels 110(1)-110(3) (i.e., one (1), two (2), and three (3), respectively) and the egress channel priority 116(1) (i.e., one (1)). As shown in FIG. 2A, the absolute difference 204(0) is zero (0) (i.e., the absolute value of 1-1); the absolute difference 204(1) is one (1) (i.e., the absolute value of 2-1); and the absolute difference 204(2) is two (2) (i.e., the absolute value of 3-1). The data allocation circuit 106 next allocates the egress channel 112(1) to the unpaired ingress channel 110(1)-110(3) that corresponds to the smallest absolute difference 204(0)-204(2) (i.e., the ingress channel 110(1) corresponding to the absolute difference 204(0) having a value of zero (0)) as a channel pair 202(1).

At this point, all available egress channels 112(0), 112(1) have been allocated, and the channel pairs 202(0), 202(1), comprising the ingress channel 110(0) and the egress channel 112(0) and the ingress channel 110(1) and the egress channel 112(1), respectively, have been generated. The data allocation circuit 106 therefore performs transactions 206(0), 206(1) using the corresponding channel pairs 202(0), 202(1). The resource allocation performed by the data allocation circuit 106 then continues at a time T₁ in FIG. 2B.

Referring now to FIG. 2B, the data allocation circuit 106 updates the ingress channel priorities 114(0)-114(3) and the egress channel priorities 116(0)-116(3) before performing the operations to generate channel pairs again. In this example, the new values for each of the ingress channel priorities 114(0)-114(3) are calculated as a remainder of a sum of the current ingress channel priority 114(0)-114(3) seen in FIG. 2A and a count of the transactions 206(0), 206 (1) of FIG. 2A, divided by X, as shown by the equation in Table 1 below:

TABLE 1
Equation for Calculating New Ingress Channel Priority

New Ingress Channel Priority = (Current Ingress Channel Priority + Count
of Transactions) mod X

In the example of FIG. 2B, the count of the transactions 206(0), 206 (1) is two (2), and the value of X is four (4), as noted above. Accordingly, the ingress channel priority 114(0) is updated to a value of two (2) (i.e., (0+2) mod 4)); the ingress channel priority 114(1) is updated to a value of three (3) (i.e., (1+2) mod 4)); the ingress channel priority 114(2) is updated to a value of zero (0) (i.e., (2+2) mod 4)); and the ingress channel priority 114(3) is updated to a value of one (1) (i.e., (3+2) mod 4)).

The data allocation circuit 106 also updates the egress channel priorities 116(0)-116(3) in similar fashion, with one difference. To prevent the data allocation circuit 106 from repeatedly pairing the same ingress channels 110(0)-110(3) with the same egress channels 112(0)-112(3) (and thereby starving some of the ingress channels 110(0)-110(3)), the data allocation circuit 106 adds one (1) to the egress channel priorities 116(0)-116(3) when calculating the updated values. Accordingly, the new values for each of the egress channel priorities 116(0)-116(3) are calculated as a sum of one (1) and a remainder of a sum of each egress channel priority 116(0)-116(3) and the count of the transactions 206(0), 206 (1), divided by Y, as shown by the equation in Table 2 below:

TABLE 2
Equation for Calculating New Egress Channel Priority

New Egress Channel Priority = (1 + Current Egress Channel Priority +
Count of Transactions) mod Y

As discussed above, the count of the transactions 206(0), 206 (1) is two (2), and the value of Y is four (4). Thus, the egress channel priority 116(0) is updated to a value of three (3) (i.e., (1+0+2) mod 4)); the egress channel priority 116(1) is updated to a value of zero (0) (i.e., (1+1+2) mod 4)); the egress channel priority 116(2) is updated to a value of one (1) (i.e., (1+2+2) mod 4)); and the egress channel priority 116(3) is updated to a value of two (2) (i.e., (1+3+2) mod 4)).

The data allocation circuit 106 then generates channel pairs in the same fashion described above with respect to FIG. 2A. The data allocation circuit 106 identifies the egress channel 112(1) as being an unpaired egress channel having the highest egress channel priority 116(1) of zero (0). The data allocation circuit 106 then calculates a plurality of absolute differences (captioned as “DIFF” in FIG. 2B) 208(0)-208(3) between each of the ingress channel priorities 114(0)-114(3) of the unpaired ingress channels 110(0)-110(3) (i.e., two (2), three (3), zero (0), and one (1), respectively) and the egress channel priority 116(1) (i.e., zero (0)). As seen in FIG. 2B, the absolute difference 208(0) is two (2) (i.e., the absolute value of 2-0); the absolute difference 208(1) is three (3) (i.e., the absolute value of 3-0); the absolute difference 208(2) is zero (0) (i.e., the absolute value of 0-0); and the absolute difference 208(3) is one (1) (i.e., the absolute value of 1-0).

The data allocation circuit 106 next allocates the egress channel 112(0) to the unpaired ingress channel 110(0)-110(3) that corresponds to the smallest absolute difference 208(0)-208(3). In the example of FIG. 2B, the smallest absolute difference 208(0)-208(3) is the absolute difference 208(2) with a value of zero (0). The absolute difference 208(2), in turn, corresponds to the ingress channel 110(2). As a result, the data allocation circuit 106 allocates the egress channel 112(1) to the ingress channel 110(2) as a channel pair 210(0).

The data allocation circuit 106 next identifies the unpaired egress channel 112(0), having the egress channel priority 116(0) of three (3), as the only remaining unpaired egress channel. The data allocation circuit 106 calculates a plurality of absolute differences (captioned as “DIFF” in FIG. 2B) 212(0)-212(2) between each of the ingress channel priorities 114(0), 114(1), and 114(3) of the unpaired ingress channels 110(0), 110(1), and 110(3) (i.e., two (2), three (3), and one (1), respectively) and the egress channel priority 116(0) (i.e., three (3)). As seen in FIG. 2B, the absolute difference 212(0) is one (1) (i.e., the absolute value of 2-3); the absolute difference 212(1) is zero (0) (i.e., the absolute value of 3-3); and the absolute difference 212(2) is two (2) (i.e., the absolute value of 1-3). The data allocation circuit 106 allocates the egress channel 112(0) to the unpaired ingress channel 110(0), 110(1), and 110(3) that corresponds to the smallest absolute difference 212(0)-212(2) (i.e., the ingress channel 110(1) corresponding to the absolute difference 212(1) having a value of zero (0)) as a channel pair 210(1).

Now that all of the available egress channels 112(0), 112(1) have been allocated and the channel pairs 210(0), 210(1) have been generated, the data allocation circuit 106 performs transactions 214(0), 214(1) using the corresponding channel pairs 210(0), 210(1). The resource allocation performed by the data allocation circuit 106 then continues at a time T₂ in FIG. 2C.

Turning to FIG. 2C, at time T₂, the data allocation circuit 106 again updates the ingress channel priorities 114(0)-114(3) and the egress channel priorities 116(0)-116(3) in the manner discussed above. As seen in FIG. 2C, the ingress channel priority 114(0) is updated to a value of zero (0) (i.e., (2+2) mod 4)); the ingress channel priority 114(1) is updated to a value of one (1) (i.e., (3+2) mod 4)); the ingress channel priority 114(2) is updated to a value of two (2) (i.e., (0+2) mod 4)); and the ingress channel priority 114(3) is updated to a value of three (3) (i.e., (1+2) mod 4)). The data allocation circuit 106 also updates the egress channel priorities 116(0)-116(3) as detailed above, resulting in the egress channel priority 116(0) being updated to a value of two (2) (i.e., (1+3+2) mod 4)); the egress channel priority 116(1) being updated to a value of three (3) (i.e., (1+0+2) mod 4)); the egress channel priority 116(2) being updated to a value of zero (0) (i.e., (1+1+2) mod 4)); and the egress channel priority 116(3) being updated to a value of one (1) (i.e., (1+2+2) mod 4)).

The data allocation circuit 106 next generates channel pairs in the same fashion described above with respect to FIGS. 2A-2B. The data allocation circuit 106 identifies the egress channel 112(0) as being the unpaired egress channel having the highest egress channel priority 116(0) of two (2), and calculates a plurality of absolute differences (captioned as “DIFF” in FIG. 2C) 216(0)-216(3) between each of the ingress channel priorities 114(0)-114(3) of the unpaired ingress channels 110(0)-110(3) (i.e., zero (0), one (1), two (2), and three (3), respectively) and the egress channel priority 116(0) (i.e., two (2)). As shown in FIG. 2C, the absolute difference 216(0) is two (2) (i.e., the absolute value of 0-2); the absolute difference 216(1) is one (1) (i.e., the absolute value of 1-2); the absolute difference 216(2) is zero (0) (i.e., the absolute value of 2-2); and the absolute difference 216(3) is one (1) (i.e., the absolute value of 3-2). The data allocation circuit 106 allocates the egress channel 112(0) to the unpaired ingress channel 110(0)-110(3) that corresponds to the smallest absolute difference 216(0)-216(3). In the example of FIG. 2C, the smallest absolute difference 216(0)-216(3) is the absolute difference 216(2), having a value of zero (0), which corresponds to the ingress channel 110(2). Thus, the data allocation circuit 106 allocates the egress channel 112(0) to the ingress channel 110(2) as a channel pair 218(0).

The data allocation circuit 106 then identifies the unpaired egress channel 112(1), having the egress channel priority 116(1) of three (3), as the only remaining unpaired egress channel. The data allocation circuit 106 calculates a plurality of absolute differences (captioned as “DIFF” in FIG. 2C) 220(0)-220(2) between each of the ingress channel priorities 114(0), 114(1), and 114(3) of the unpaired ingress channels 110(0), 110(1), and 110(3) (i.e., zero (0), one (1), and three (3), respectively) and the egress channel priority 116(1) (i.e., three (3)). As FIG. 2C shows, the absolute difference 220(0) is three (3) (i.e., the absolute value of 0-3); the absolute difference 220(1) is two (0) (i.e., the absolute value of 1-3); and the absolute difference 220(2) is zero (0) (i.e., the absolute value of 3-3). The data allocation circuit 106 therefore allocates the egress channel 112(1) to the unpaired ingress channel 110(0), 110(1), and 110(3) that corresponds to the smallest absolute difference 220(0)-220(2) (i.e., the ingress channel 110(3) corresponding to the absolute difference 220(2) having a value of zero (0)) as a channel pair 218(1).

Once all of the available egress channels 112(0), 112(1) have been allocated and the channel pairs 218(0), 218(1) have been generated, the data allocation circuit 106 performs transactions 222(0), 222(1) using the corresponding channel pairs 218(0), 218(1). The resource allocation performed by the data allocation circuit 106 then continues at a time T₃ in FIG. 2D.

With reference to FIG. 2D, the data allocation circuit 106, at time T₃, again updates the ingress channel priorities 114(0)-114(3) and the egress channel priorities 116(0)-116(3) in the manner discussed above. As shown in FIG. 2D, the ingress channel priority 114(0) is updated to a value of two (2) (i.e., (0+2) mod 4)); the ingress channel priority 114(1) is updated to a value of three (3) (i.e., (1+2) mod 4)); the ingress channel priority 114(2) is updated to a value of zero (0) (i.e., (2+2) mod 4)); and the ingress channel priority 114(3) is updated to a value of one (1) (i.e., (3+2) mod 4)). The data allocation circuit 106 further updates the egress channel priorities 116(0)-116(3) as detailed above, resulting in the egress channel priority 116(0) being updated to a value of one (1) (i.e., (1+2+2) mod 4)); the egress channel priority 116(1) being updated to a value of two (2) (i.e., (1+3+2) mod 4)); the egress channel priority 116(2) being updated to a value of three (3) (i.e., (1+0+2) mod 4)); and the egress channel priority 116(3) being updated to a value of zero (0) (i.e., (1+1+2) mod 4)).

The data allocation circuit 106 then generates channel pairs in the same manner described above with respect to FIGS. 2A-2C. The data allocation circuit 106 identifies the egress channel 112(0) as being an unpaired egress channel having the highest egress channel priority 116(0) of one (1), and calculates a plurality of absolute differences (captioned as “DIFF” in FIG. 2D) 224(0)-224(3) between each of the ingress channel priorities 114(0)-114(3) of the unpaired ingress channels 110(0)-110(3) (i.e., two (2), three (3), zero (0), and one (1), respectively) and the egress channel priority 116(0) (i.e., one (1)). As seen in FIG. 2D, the absolute difference 224(0) is one (1) (i.e., the absolute value of 2-1); the absolute difference 224(1) is two (2) (i.e., the absolute value of 3-1); the absolute difference 224(2) is one (1) (i.e., the absolute value of 0-1); and the absolute difference 224(3) is zero (0) (i.e., the absolute value of 1-1). The data allocation circuit 106 allocates the egress channel 112(0) to the unpaired ingress channel 110(0)-110(3) that corresponds to the smallest absolute difference 224(0)-224(3). In the example of FIG. 2D, the smallest absolute difference 224(0)-224(3) is the absolute difference 224(3) with a value of zero (0). The absolute difference 224(3) in turn corresponds to the ingress channel 110(3). Thus, the data allocation circuit 106 allocates the egress channel 112(0) to the ingress channel 110(3) as a channel pair 226(0).

The data allocation circuit 106 next identifies the unpaired egress channel 112(1), having the egress channel priority 116(1) of two (2), as the only remaining unpaired egress channel. The data allocation circuit 106 calculates a plurality of absolute differences (captioned as “DIFF” in FIG. 2D) 228(0)-228(2) between each of the ingress channel priorities 114(0)-114(2) of the unpaired ingress channels 110(0)-110(2) (i.e., two (2), three (3), and zero (0), respectively) and the egress channel priority 116(1) (i.e., two (2)). As seen in FIG. 2D, the absolute difference 228(0) is zero (2) (i.e., the absolute value of 2-2); the absolute difference 228(1) is one (1) (i.e., the absolute value of 2-3); and the absolute difference 228(2) is two (2) (i.e., the absolute value of 2-0). The data allocation circuit 106 allocates the egress channel 112(1) to the unpaired ingress channel 110(0)-110(2) that corresponds to the smallest absolute difference 228(0)-228(2) (i.e., the ingress channel 110(0) corresponding to the absolute difference 228(0) having a value of zero (0)) as a channel pair 226(1).

Because all of the available egress channels 112(0), 112(1) have been allocated and the channel pairs 226(0), 226(1) have been generated, the data allocation circuit 106 performs transactions 230(0), 230(1) using the corresponding channel pairs 226(0), 226(1). Note that the next updates to the ingress channel priorities 114(0)-114(3) and the egress channel priorities 116(0)-116(3) will result in the state shown in FIG. 2A at time T₀.

Some embodiments of the data allocation circuit 106 are configured to enable more advanced variations of load balancing through the use of groups. In this regard, FIGS. 3A-3B illustrate exemplary resource arbitration performed by the data allocation circuit 106 in such embodiments when operating in a group-based load-balancing mode. In FIGS. 3A-3B, the data allocation circuit 106 of FIG. 1 is shown, along with the ingress channels (captioned as “INGRESS” in FIGS. 3A-3B) 110(0)-110(3) (i.e., C=3 in this example) associated with the corresponding requestors 108(0)-108(3). FIGS. 3A-3B also illustrate the egress channels (captioned as “EGRESS” in FIGS. 3A-3B) 112(0)-112(3) (i.e., E=3 in this example) of FIG. 1 associated with the shared resource device 104. Additionally, FIGS. 3A-3B also show the ingress channel priorities (captioned as “IN PRI” in FIGS. 3A-3B) 114(0)-114(3) and the egress channel priorities (captioned as “EG PRI” in FIGS. 3A-3B) 116(0)-116(3) of FIG. 1. The data allocation circuit 106 in the example of FIGS. 3A-3B is receiving requests from all of the requestors 108(0)-108(3) via the ingress channels 110(0)-110(3), while only the egress channels 112(0), 112(2) are available. Each of FIGS. 3A-3B illustrates an internal state of the data allocation circuit 106 at respective points in time T₀-T₁.

In FIG. 3A, the state of the data allocation circuit 106 at a time T₀ is shown. The data allocation circuit 106 organizes the ingress channels 110(0)-110(3) and the egress channels 112(0)-112(3) into two groups 300(0), 300(1). The group 300(0) includes the ingress channels 110(0), 110(1) and the egress channels 112(0), 112(1), while the group 300(1) includes the ingress channels 110(2), 110(3) and the egress channels 112(2), 112(3). It is to be understood that some embodiments may provide a larger number of groups than the two (2) groups 300(0), 300(1) shown in FIGS. 3A-3B.

The data allocation circuit 106 assigns group priorities (captioned as “GROUP PRI” in FIGS. 3A-3B) 306(0), 306(1) to the groups 300(0), 300(1), respectively. In the example of FIGS. 3A-3B, to assign the group priorities 306(0), 306(1), the data allocation circuit 106 first assigns, to each of the group 300(0), 300(1), a corresponding individual priority (captioned as “INDIV PRI” in FIGS. 3A-2B) 302(0), 302(1) as a unique value between zero (0) and Z−1 inclusive, wherein Z is an integer representing a count of the groups 300(0), 300(1). Thus, in this example, the group 300(0) is assigned the individual priority 302(0) of zero (0), while the group 300(1) is assigned the individual priority 302(1) of one (1). The data allocation circuit 106 then determines a group offset 304 as an integer that is larger than a largest count of ingress channels 110(0)-110(3) in each group of the plurality of groups 300(0), 300(1), and that can be evenly divided by the largest count of ingress channels 110(0)-110(3) in each group of the plurality of groups 300(0), 300(1). Here, the largest count of ingress channels 110(0)-113(0) in each group is two (2), and thus the group offset 304 is determined to be four (4) (i.e., the next integer that is larger than two (2) and is divisible by two (2)). Finally, the data allocation circuit 106 assigns, to each of the groups 300(0), 300(1), a corresponding group priority 306(0), 306(1) as a product of the corresponding individual priority 302(0), 302(1) and the group offset 304. Accordingly, the group priority 306(0) is zero (0) (i.e., 0×4), while the group priority 306(1) is four (4) (i.e., 1×4).

The data allocation circuit 106 assigns the ingress channel priorities 114(0)-114(3) to the corresponding ingress channels 110(0)-110(3). Each of the ingress channel priorities 114(0)-114(3) is assigned as a unique value between zero (0) and M−1 inclusive, wherein M is an integer (two (2), in this example) representing a count of the ingress channels 110(0)-110(3) in each group 300(0), 300(1). Accordingly, in the example of FIG. 3A, the ingress channel 110(0) is assigned an initial ingress channel priority 114(0) of zero (0), while the ingress channel 110(1) is assigned an initial ingress channel priorities 114(1) of one (1) (i.e., the sum of 0+1). Similarly, the ingress channel 110(2) is assigned an initial ingress channel priority 114(2) of zero (0), and the ingress channel 110(3) is assigned an initial ingress channel priority 114(3) of one (1).

The data allocation circuit 106 also assigns the egress channel priorities 116(0)-116(3) to the corresponding egress channels 112(0)-112(3) in similar fashion. Each of the egress channel priorities 116(0)-116(3) is a unique value between zero (0) and N−1 inclusive, wherein N is an integer (two (2), in this example) representing a count of the one or more egress channels 112(0)-112(3) in each group 300(0), 300(1). As seen in FIG. 3A, the egress channel 112(0) is assigned an initial egress channel priority 116(0) of zero (0), while the egress channel 112(1) is assigned an initial egress channel priorities 116(1) of one (1) (i.e., the sum of 0+1). The egress channel 112(2) is assigned an initial egress channel priority 116(2) of zero (0), and the egress channel 112(3) is assigned an initial egress channel priority 116(3) of one (1) (i.e., the sum of 0+1).

The data allocation circuit 106 next iteratively generates channel pairs. Note that the data allocation circuit 106 in the example of FIGS. 3A-3B is configured to operate in a group-based mode, such that the egress channels 112(0), 112(2) are allocated only to ingress channels 110(0)-110(3) that are within the same corresponding groups 300(0), 300(1). Thus, in FIG. 3A, the data allocation circuit 106 first identifies an unpaired egress channel among the egress channels 112(0), 112(2) that has a highest combination priority of the group priority 306(0), 306(1) and the egress channel priority 116(0), 116(2). In the example of FIG. 3A, the egress channel 112(0) is the unpaired egress channel with the highest combination priority of the group priority 306(0) (i.e., zero (0)) and the egress channel priority 116(0) (i.e., zero (0)), for a combined priority of zero (0).

The data allocation circuit 106 then calculates a plurality of absolute differences (captioned as “DIFF” in FIG. 3A) 308(0), 308(1) between a sum of the group priority 306(0) (i.e., zero (0)) and each of the ingress channel priorities 114(0), 114(1) of the unpaired ingress channels 110(0), 110(1) (i.e., zero (0) and one (1), respectively) within the same group 300(0), and a sum of the group priority 306(0) and the egress channel priority 116(0) (i.e., zero (0)). As seen in FIG. 3A, the absolute difference 308(0) is zero (0) (i.e., the absolute value of (0+0)-(0+0)), while the absolute difference 308(1) is one (1) (i.e., the absolute value of (0+1)-(0+0)). The data allocation circuit 106 next allocates the egress channel 112(0) to the unpaired ingress channel 110(0), 110(1) that corresponds to the smallest absolute difference 308(0), 308(1). In FIG. 3A, the smallest absolute difference 308(0), 308(1) is the absolute difference 308(0) with a value of zero (0). The absolute difference 308(0) in turn corresponds to the ingress channel 110(0). Accordingly, the data allocation circuit 106 allocates the egress channel 112(0) to the ingress channel 110(0) as a channel pair 310(0).

Since both the ingress channels 110(1)-110(3) and the egress channel 112(2) remain unpaired, the data allocation circuit 106 performs the series of operations again. The data allocation circuit 106 identifies the unpaired egress channel 112(2), having the egress channel priority 116(2) of four (4), as the only remaining unpaired egress channel. The data allocation circuit 106 then calculates the absolute differences (captioned as “DIFF” in FIG. 3A) 312(0), 312(1) between a sum of the group priority 306(1) (i.e., four (4)) and each of the ingress channel priorities 114(2), 114(3) (i.e., zero (0) and one (1), respectively) of the unpaired ingress channels 110(2), 110(3) within the same group 300(1), and a sum of the group priority 306(1) (i.e., four (4)) and the egress channel priority 116(2) (i.e., zero (0)). As shown in FIG. 3A, the absolute difference 312(0) is zero (0) (i.e., the absolute value of (4+0)-(4+0)), while the absolute difference 312(1) is one (1) (i.e., the absolute value of (4+1)-(4+0)). The data allocation circuit 106 therefore allocates the egress channel 112(2) to the unpaired ingress channel 110(2), 110(3) that corresponds to the smallest absolute difference 312(0), 312(1) (i.e., the ingress channel 110(2) corresponding to the absolute difference 312(0) having a value of zero (0)) as a channel pair 310(1).

At this point, all of the available egress channels 112(0), 112(2) have been allocated, and the channel pairs 310(0), 310(1), comprising the ingress channel 110(0) and the egress channel 112(0) and the ingress channel 110(2) and the egress channel 112(2), respectively, have been generated. The data allocation circuit 106 thus performs transactions 314(0), 314(1) using the corresponding channel pairs 310(0), 310(1). The resource allocation performed by the data allocation circuit 106 then continues at a time T₁ in FIG. 3B.

Referring now to FIG. 3B, the data allocation circuit 106 updates the ingress channel priorities 114(0)-114(3) and the egress channel priorities 116(0)-116(3) before performing the operations to generate channel pairs again. As discussed above with respect to FIGS. 2A-2D, the new values for each of the ingress channel priorities 114(0)-114(3) are calculated as a remainder of a sum of each current ingress channel priority 114(0)-114(3) seen in FIG. 3A and a count of the transactions 314(0), 314(1), divided by M. In the example of FIG. 3B, the count of the transactions 314(0), 314(1) is two (2), and the value of M is two (2), as noted above. Accordingly, the ingress channel priority 114(0) is updated to a value of zero (0) (i.e., (0+2) mod 2); the ingress channel priority 114(1) is updated to a value of one (1) (i.e., (1+2) mod 2); the ingress channel priority 114(2) is updated to a value of zero (0) (i.e., (0+2) mod 2); and the ingress channel priority 114(3) is updated to a value of one (1) (i.e., (1+2) mod 2).

The data allocation circuit 106 also updates the egress channel priorities 116(0)-116(3) in similar fashion, with the addition of one (1) to the egress channel priorities 116(0)-116(3) when performing the update. Thus, the new values for each of the egress channel priorities 116(0)-116(3) are calculated as a remainder of a sum of one (1), each current egress channel priority 116(0)-116(3), and the count of the transactions 314(0), 314(1), divided by N. As noted above, the count of the transactions 314(0), 314(1) is two (2), and the value of N is two (2). The egress channel priority 116(0) therefore is updated to a value of one (1) (i.e., (1+0+2) mod 2); the egress channel priority 116(1) is updated to a value of zero (0) (i.e., (1+1+2) mod 2); the egress channel priority 116(2) is updated to a value of one (1) (i.e., (1+0+2) mod 2); and the egress channel priority 116(3) is updated to a value of zero (0) (i.e., (1+1+2) mod 2).

Additionally, the data allocation circuit 106 updates each individual priority 302(0), 302(1) of each group 300(0), 300(1) as a remainder of a sum of the individual priority 302(0), 302(1) of each group 300(0), 300(1) and a count of the transactions 314(0), 314(1) (i.e., two (2)), divided by Z (i.e., two (2)). Accordingly, the individual priority 302(0) is updated to a value of zero (0) (i.e., (0+2) mod 2)), while the individual priority 302(1) is updated to a value of one (1) (i.e., (1+2) mod 2). Finally, the data allocation circuit 106 updates the group priority 306(0), 306(1) of each group 300(0), 300(1) as a product of the corresponding individual priority 302(0), 302(1) and the group offset 304 (i.e., four (4)). Thus, the group priority 306(0) is updated to a value of zero (0) (i.e., 0×4), and the group priority 306(1) is updated to a value of four (4) (i.e., 1×4).

The data allocation circuit 106 then generates channel pairs in the same fashion described above with respect to FIG. 3A. The data allocation circuit 106 identifies the egress channel 112(0) as being an unpaired egress channel having the highest combination priority of group priority (i.e., the group priority 306(0) of zero (0)) and egress channel priority (i.e., the egress channel priority 116(0) of one (1)). The data allocation circuit 106 then calculates a plurality of absolute differences (captioned as “DIFF” in FIG. 3B) 316(0), 316(1) between a sum of the group priority 306(0) (i.e., zero (0)) and each of the ingress channel priorities 114(0), 114(1) (i.e., zero (0) and one (1), respectively) of the unpaired ingress channels 110(0), 110(1), and a sum of the group priority 306(0) (i.e., zero (0)) and the egress channel priority 116(0) (i.e., one (1)). As seen in FIG. 3B, the absolute difference 316(0) is one (1) (i.e., the absolute value of (0+0)-(0+1)), while the absolute difference 316(1) is zero (0) (i.e., the absolute value of (0+1)-(0+1)).

The data allocation circuit 106 allocates the egress channel 112(0) to the unpaired ingress channel 110(0), 110(1) that corresponds to the smallest absolute difference 316(0), 316(1). In the example of FIG. 3B, the smallest absolute difference 316(0), 316(1) is the absolute difference 316(1) with a value of zero (0). The absolute difference 316(1) in turn corresponds to the ingress channel 110(1). The data allocation circuit 106 thus allocates the egress channel 112(0) to the ingress channel 110(1) as a channel pair 318(0).

The data allocation circuit 106 next identifies the unpaired egress channel 112(2), having the egress channel priority 116(1) of five (5), as the only remaining unpaired egress channel. The data allocation circuit 106 calculates a plurality of absolute differences (captioned as “DIFF” in FIG. 3B) 320(0), 320(1) between a sum of the group priority 306(1) (i.e., four (4)) and each of the ingress channel priorities 114(2), 114(3) (i.e., zero (0) and one (1), respectively) of the unpaired ingress channels 110(2), 110(3), and a sum of the group priority 306(1) (i.e., four (4)) and the egress channel priority 116(2) (i.e., one (1)). As seen in FIG. 3B, the absolute difference 320(0) is one (1) (i.e., the absolute value of (4+0)-(4+1)), while the absolute difference 320(1) is zero (0) (i.e., the absolute value of (4+1)-(4+1)). The data allocation circuit 106 thus allocates the egress channel 112(2) to the unpaired ingress channel 110(2), 110(3) that corresponds to the smallest absolute difference 320(0), 320(1) (i.e., the ingress channel 110(3) corresponding to the absolute difference 320(1) having a value of zero (0)) as a channel pair 318(1).

Because all of the available egress channels 112(0), 112(2) have been allocated and the channel pairs 318(0), 318(1) have been generated, the data allocation circuit 106 performs transactions 322(0), 322(1) using the corresponding channel pairs 318(0), 318(1). Note that the next updates to the ingress channel priorities 114(0)-114(3) and the egress channel priorities 116(0)-116(3) will result in the state shown in FIG. 3A at time T₀.

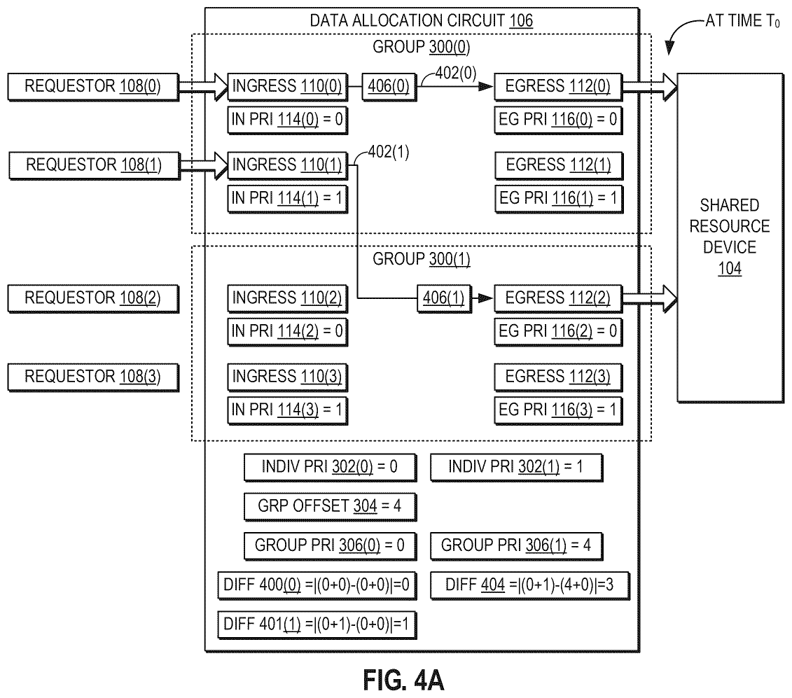

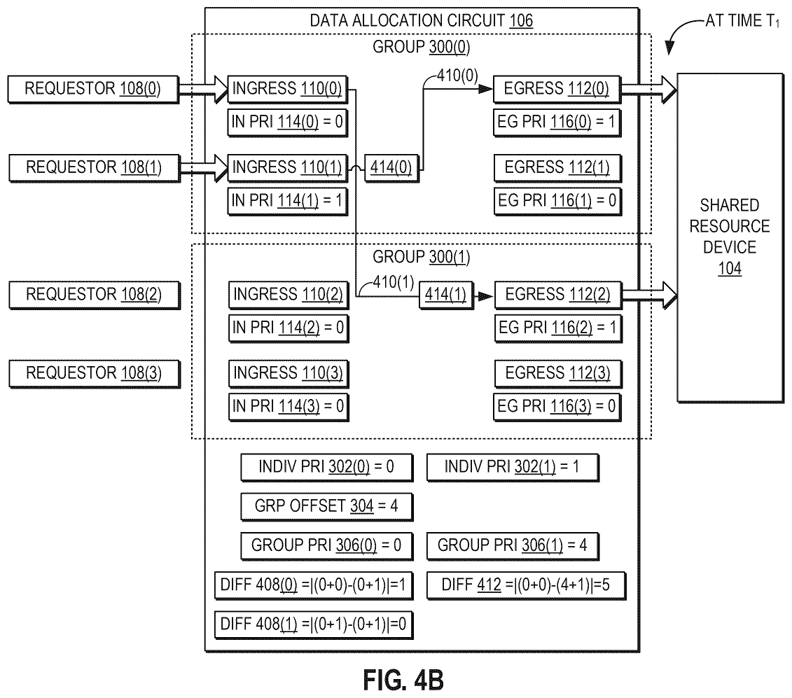

FIGS. 4A-4B illustrate exemplary resource arbitration performed by embodiments of the data allocation circuit 106 when operating in a group-based load-balancing mode in which cross-group allocation is permitted. FIGS. 4A-4B show the data allocation circuit 106 of FIG. 1 including the ingress channels (captioned as “INGRESS” in FIGS. 4A-4B) 110(0)-110(3) (i.e., C=3 in this example) of FIG. 1 associated with corresponding requestors 108(0)-108(3) and the egress channels (captioned as “EGRESS” in FIGS. 4A-4B) 112(0)-112(3) (i.e., E=3 in this example) of FIG. 1 associated with the shared resource device 104. The ingress channels 110(0)-110(3) and the egress channels 112(0)-112(3) are organized into the groups 300(0), 300(1) of FIGS. 3A-3B. FIGS. 4A-4B also show the ingress channel priorities (captioned as “IN PRI” in FIGS. 4A-4B) 114(0)-114(3) and the egress channel priorities (captioned as “EG PRI” in FIGS. 4A-4B) 116(0)-116(3) of FIG. 1, along with the individual priorities (captioned as “INDIV PRI” in FIGS. 4A-4B) 302(0), 302(1), the group offset (captioned as “GRP OFFSET” in FIGS. 4A-4B) 304, and the group priorities (captioned as “GROUP PRI” in FIGS. 4A-4B) 306(0), 306(1) of FIGS. 3A-3B. In the example of FIGS. 4A-4B, the data allocation circuit 106 only receives requests from the requestors 108(0), 108(1) via the ingress channels 110(0), 110(1), and only the egress channels 112(0), 112(2) are available. Each of FIGS. 4A-4B illustrates an internal state of the data allocation circuit 106 at respective points in time T₀-T₁.

In FIG. 4A, the state of the data allocation circuit 106 at a time T₀ is shown. The data allocation circuit 106 assigns the ingress channel priorities 114(0)-114(3) to the corresponding ingress channels 110(0)-110(3) and the egress channel priorities 116(0)-116(3) to the corresponding egress channels 112(0)-112(3) as discussed above with respect to FIGS. 3A-3B. Accordingly, the ingress channel 110(0) is assigned an initial ingress channel priority 114(0) of zero (0); the ingress channel 110(1) is assigned an initial ingress channel priority 114(1) of one (1); the ingress channel 110(2) is assigned an initial ingress channel priority 114(2) of zero (0); and the ingress channel 110(3) is assigned an initial ingress channel priority 114(3) of one (1). Likewise, the egress channel 112(0) is assigned an initial egress channel priority 116(0) of zero (0); the egress channel 112(1) is assigned an initial egress channel priorities 116(1) of one (1); the egress channel 112(2) is assigned an initial egress channel priority 116(2) of zero (0); and the egress channel 112(3) is assigned an initial egress channel priority 116(3) of one (1).

The data allocation circuit 106 next iteratively generates channel pairs in a manner similar to that discussed above with respect to FIGS. 3A-3B. Note that the data allocation circuit 106 in the example of FIGS. 4A-4B is configured to operate in a group-based mode that allows cross-group allocation, such that the egress channels 112(0), 112(2) may be allocated to ingress channels 110(0)-110(3) in different groups 300(0), 300(1). The data allocation circuit 106 thus first identifies an unpaired egress channel among the egress channels 112(0), 112(2) that has a highest combination priority of group priority 306(0), 306(1) and egress channel priority 116(0), 116(2). In the example of FIG. 4A, the egress channel 112(0) is the unpaired egress channel with the highest combination priority (i.e., the group priority 306(0) of zero (0) summed with the egress channel priority 116(0) of zero (0)).

The data allocation circuit 106 then calculates a plurality of absolute differences (captioned as “DIFF” in FIG. 4A) 400(0), 400(1) between a sum of the group priority 306(0) (i.e., zero (0)) and each of the ingress channel priorities 114(0), 114(1) of the unpaired ingress channels 110(0), 110(1) (i.e., zero (0) and one (1), respectively), and a sum of the group priority 306(0) (i.e., zero (0)) and the egress channel priority 116(0) (i.e., zero (0)). As seen in FIG. 4A, the absolute difference 400(0) is zero (0) (i.e., the absolute value of (0+0)-(0+0)), while the absolute difference 400(1) is one (1) (i.e., the absolute value of (0+1)-(0+0)). The data allocation circuit 106 next allocates the egress channel 112(0) to the unpaired ingress channel 110(0), 110(1) that corresponds to the smallest absolute difference 400(0), 400(1). In FIG. 4A, the smallest absolute difference 400(0), 400(1) is the absolute difference 400(0) with a value of zero (0). The absolute difference 400(0) in turn corresponds to the ingress channel 110(0). Thus, the data allocation circuit 106 allocates the egress channel 112(0) to the ingress channel 110(0) as a channel pair 402(0).

Since the ingress channels 110(1)-110(3) and the egress channel 112(2) remain unpaired, the data allocation circuit 106 performs the series of operations again. The data allocation circuit 106 identifies the unpaired egress channel 112(2), having the egress channel priority 116(2) of zero (0), as the only remaining unpaired egress channel. However, since the ingress channels 110(2), 110(3) in the group 300(1) to which the egress channel 112(2) belongs are not active, the data allocation circuit 106 calculates an absolute difference (captioned as “DIFF” in FIG. 4A) 404 between a sum of the group priority 306(0) (i.e., zero (0)) and the ingress channel priority 114(1) (i.e., one (1)) of the unpaired ingress channel 110(1), and a sum of the group priority 306(1) (i.e., four (4)) and the egress channel priority 116(2) (i.e., zero (0)). As shown in FIG. 4A, the absolute difference 404 is three (3) (i.e., the absolute value of (0+1)-(4+0)). Since only one absolute difference 404 is calculated, the absolute difference 404 is the smallest absolute difference, and thus the data allocation circuit allocates the egress channel 112(2) to the ingress channel 110(1) corresponding to the absolute difference 404 as a channel pair 402(1).

At this point, all of the available egress channels 112(0), 112(2) have been allocated, and the channel pairs 402(0), 402(1), comprising the ingress channel 110(0) and the egress channel 112(0) and the ingress channel 110(1) and the egress channel 112(2), respectively, have been generated. The data allocation circuit 106 thus performs transactions 406(0), 406(1) using the corresponding channel pairs 402(0), 402(1). The resource allocation performed by the data allocation circuit 106 then continues at a time T₁ in FIG. 4B.

Referring now to FIG. 4B, the data allocation circuit 106 updates the ingress channel priorities 114(0)-114(3), the egress channel priorities 116(0)-116(3), the individual priorities 302(0), 302(1), and the group priorities 306(0), 306(1) in the same manner discussed above with respect to FIG. 3B. Accordingly, the ingress channel priority 114(0) is updated to a value of zero (0); the ingress channel priority 114(1) is updated to a value of one (1); the ingress channel priority 114(2) is updated to a value of four (4); and the ingress channel priority 114(3) is updated to a value of five (5). Similarly, the egress channel priority 116(0) is updated to a value of one (1); the egress channel priority 116(2) is updated to a value of zero (0); the egress channel priority 116(2) is updated to a value of five (5); and the egress channel priority 116(3) is updated to a value of four (4). With respect to the groups 300(0), 300(1), the individual priority 302(0) is updated to a value of zero (0), and the individual priority 302(1) is updated to a value of one (1). The group priority 306(0) is updated to a value of zero (0), while the group priority 306(1) is updated to a value of four (4).

The data allocation circuit 106 then generates channel pairs in the same fashion described above with respect to FIG. 4A. The data allocation circuit 106 identifies the egress channel 112(0) as being an unpaired egress channel having the highest combination priority of group priority (i.e., the group priority 306(0) of zero (0)) and egress channel priority (i.e., the egress channel priority 116(0) of one (1)). The data allocation circuit 106 then calculates a plurality of absolute differences (captioned as “DIFF” in FIG. 4B) 408(0), 408(1) between a sum of the group priority 306(0) (i.e., zero (0)) and each of the ingress channel priorities 114(0), 114(1) (i.e., zero (0) and one (1), respectively) of the unpaired ingress channels 110(0), 110(1), and a sum of the group priority 306(0) (i.e., zero (0)) and the egress channel priority 116(0) (i.e., one (1)). As seen in FIG. 4B, the absolute difference 408(0) is one (1) (i.e., the absolute value of (0+0)-(0+1)), while the absolute difference 408(1) is zero (0) (i.e., the absolute value of (0+1)-(0+1)).

The data allocation circuit 106 allocates the egress channel 112(0) to the unpaired ingress channel 110(0), 110(1) that corresponds to the smallest absolute difference 408(0), 408(1). In the example of FIG. 4B, the smallest absolute difference 408(0), 408(1) is the absolute difference 408(1) with a value of zero (0). The absolute difference 408(1) in turn corresponds to the ingress channel 110(1). Thus, the data allocation circuit 106 allocates the egress channel 112(0) to the ingress channel 110(1) as a channel pair 410(0).

The data allocation circuit 106 next identifies the unpaired egress channel 112(2), having the egress channel priority 116(2) of five (5), as the only remaining unpaired egress channel. Because the ingress channels 110(2), 110(3) in the group 300(1) to which the egress channel 112(2) belongs are not active, the data allocation circuit 106 calculates the absolute difference (captioned as “DIFF” in FIG. 4B) 412 between a sum of the group priority 306(0) (i.e., zero (0)) and the ingress channel priority 114(0) (i.e., zero (0)), and a sum of the group priority 306(1) (i.e., four (4)) and the egress channel priority 116(2) (i.e., one (1)) as five (5) (i.e., the absolute value of (0+0)-(4+1)). The data allocation circuit 106 allocates the egress channel 112(2) to the unpaired ingress channel that corresponds to the absolute difference 412 (i.e., the ingress channel 110(0)) as a channel pair 410(1).

Because all of the available egress channels 112(0), 112(2) have been allocated and the channel pairs 410(0), 410(1) have been generated, the data allocation circuit 106 performs transactions 414(0), 414(1) using the corresponding channel pairs 410(0), 410(1).

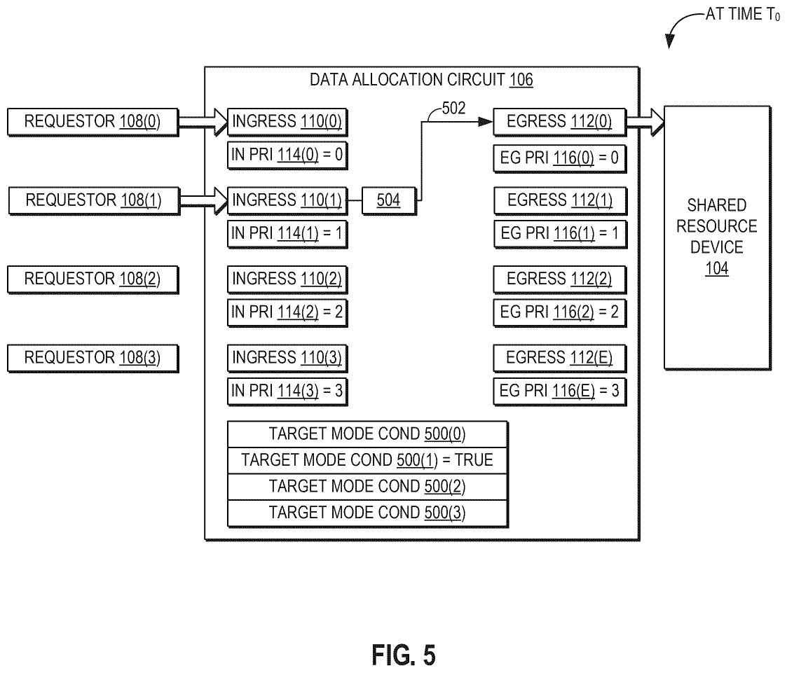

FIG. 5 is a block diagram illustrating exemplary resource arbitration by the data allocation circuit 106 of FIG. 1 when operating in a target mode, according to some embodiments. The target mode enables the data allocation circuit 106 to override the load-balancing functionality discussed above with respect to FIGS. 2A-2D, 3A-3B, and 4A-4B for ingress channels for which specified conditions are met, and to apply the load-balancing functionality to ingress channels for which the specified conditions are not met. In this manner, the data allocation circuit 106 in such embodiments can provide additional flexibility to meet quality of service (QoS) requirements.

As seen in FIG. 5, the data allocation circuit 106 of FIG. 1 is illustrated, along with the ingress channels (captioned as “INGRESS” in FIG. 5) 110(0)-110(3) (i.e., C=3 in this example) of FIG. 1 associated with corresponding requestors 108(0)-108(3) and the egress channels (captioned as “EGRESS” in FIG. 5) 112(0)-112(3) (i.e., E=3 in this example) of FIG. 1 associated with the shared resource device 104. FIG. 5 also shows the ingress channel priorities (captioned as “IN PRI” in FIG. 5) 114(0)-114(3) and the egress channel priorities (captioned as “EG PRI” in FIG. 5) 116(0)-116(3) of FIG. 1, In the example of FIG. 5, at a time T₀, the data allocation circuit 106 is receiving requests from only the requestors 108(0), 108(1) via the ingress channels 110(0), 110(1), and only the egress channel 112(0) is available.

The data allocation circuit 106 also includes target mode conditions (captioned as “TARGET MODE COND” in FIG. 5) 500(0)-500(3) corresponding to the ingress channels 110(0)-110(3). Each of the target mode conditions 500(0)-500(3) comprises a configurable logic circuit that evaluates whether the target mode conditions 500(0)-500(3) is satisfied (e.g., evaluates to true) for the corresponding ingress channel 110(0)-110(3). For example, the target mode conditions 500(0)-500(3) each may comprise a transaction counter (not shown), along with logic to compare the transaction counter with a transaction threshold (not shown) and return a value of true if the transaction counter is less than the transaction threshold. This can be used to allow the ingress channels 110(0)-110(3) that are associated with a high QoS requirement to be exempted from the load-balancing functionality of the data allocation circuit 106, and instead to be prioritized when allocating available egress channels 112(0)-112(3). It is to be understood that the target mode conditions 500(0)-500(3) may include other logical elements, such as True/False indicators, bypass logic, and/or AND, OR, and/or XOR operators.

In the example of FIG. 5, it is assumed that the target mode condition 500(1) corresponding to the ingress channel 110(1) is satisfied (i.e., evaluates to true). Thus, instead of performing the load-balancing operations discussed above with respect to FIGS. 2A-2D, 3A-3B, and 4A-4B, the data allocation circuit 106 generates a channel pair 502 by allocating the only available egress channel 112(0) to the ingress channel 110(1). The data allocation circuit 106 then performs a transaction 504 using the channel pair 502. If the target mode condition 500(1) comprises a transaction counter and a transaction threshold as discussed above, the data allocation circuit 106 may increment the transaction counter, and then compare it with the transaction threshold to determine whether the target mode condition 500(1) is satisfied for a subsequent time interval.

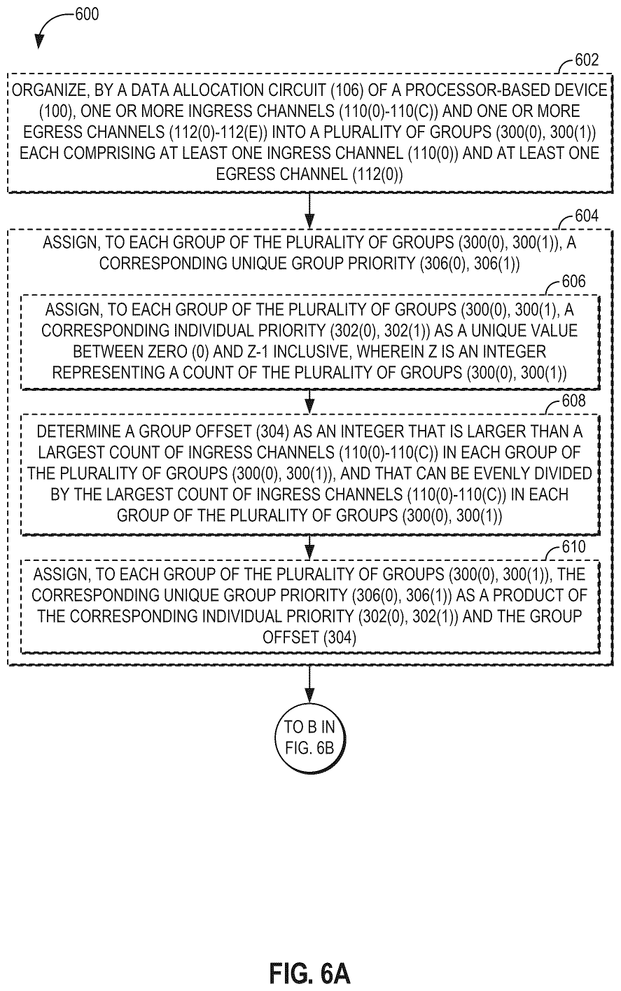

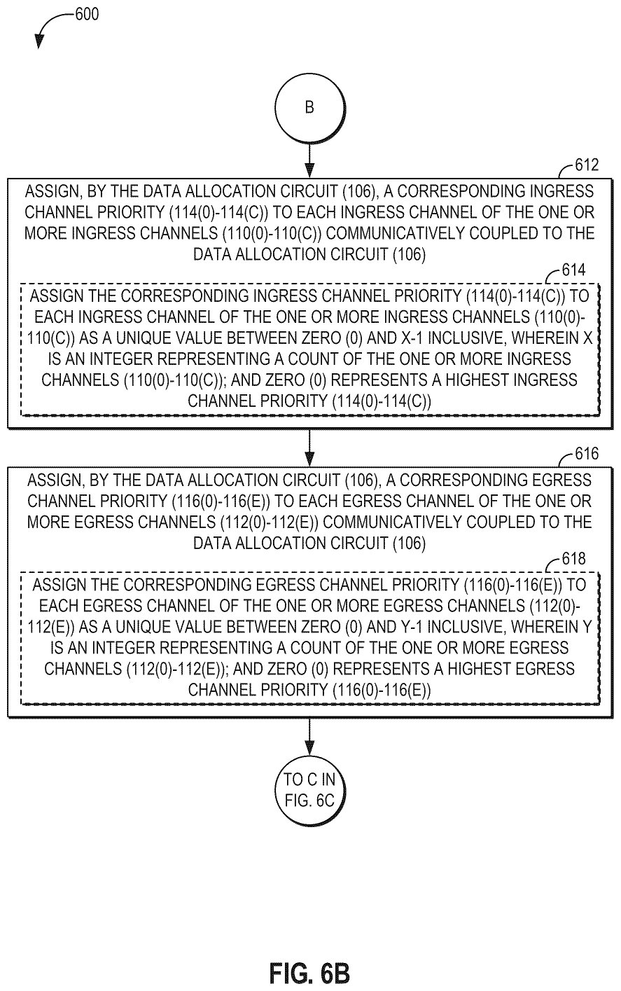

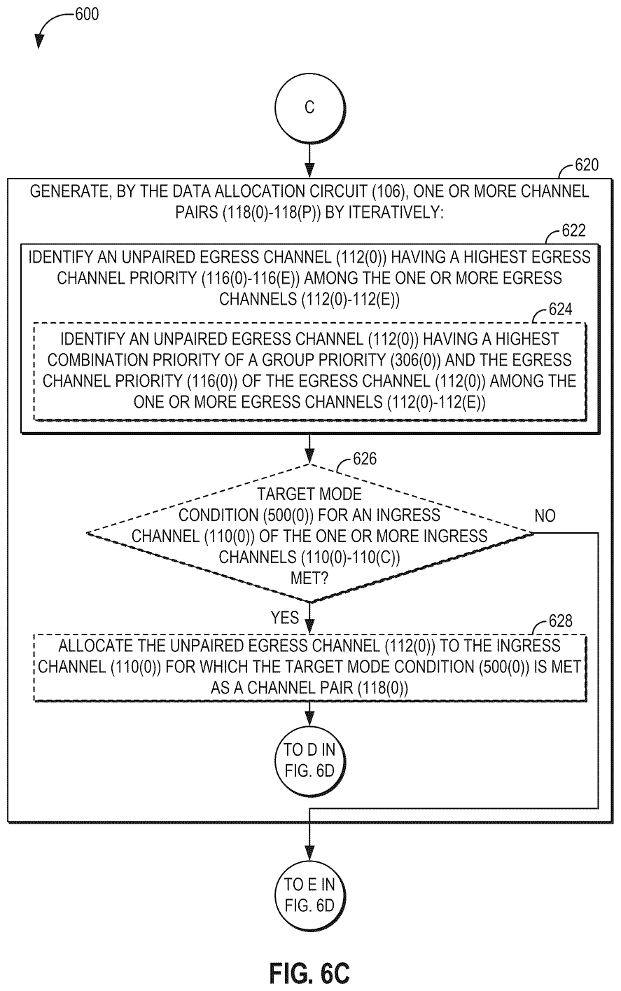

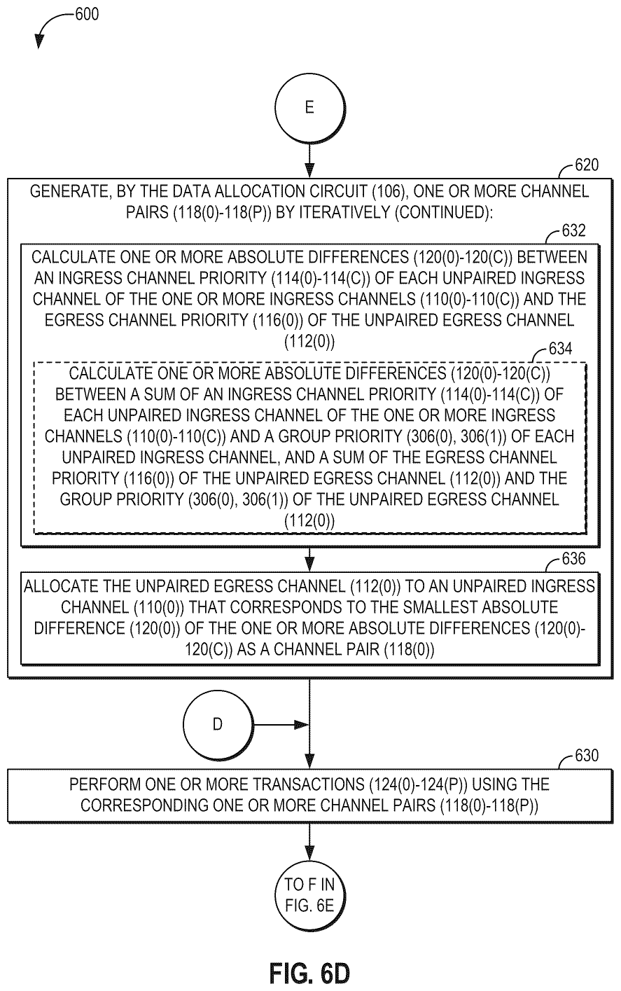

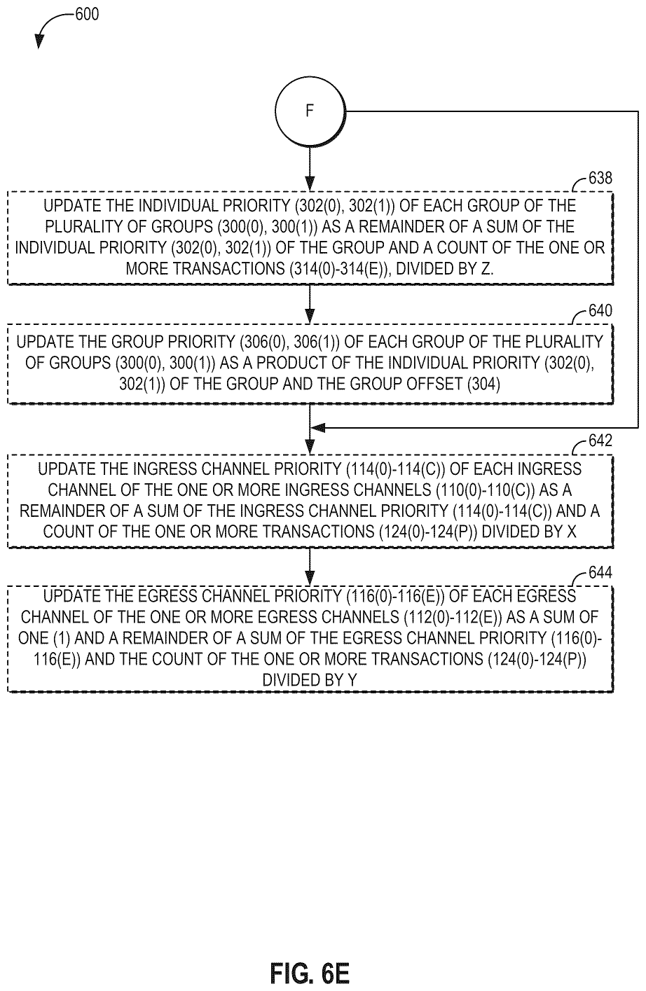

FIGS. 6A-6E provide a flowchart illustrating exemplary operations 600 of the data allocation circuit 106 of FIG. 1 for providing arbitration for resource sharing using channel priority differences, according to some embodiments. For the sake of clarity, elements of FIGS. 1-5 are referenced in describing FIGS. 6A-6E. It is to be understood that some operations illustrated in FIGS. 6A-6E may occur in an order other than that illustrated in FIGS. 6A-6E in some embodiments, and/or may be omitted in some embodiments.

In FIG. 6A, the exemplary operations 600 in some embodiments begin with a data allocation circuit (e.g., the data allocation circuit 106 of FIG. 1) of a processor-based device (such as the processor-based device 100 of FIG. 1) organizing one or more ingress channels (e.g., the one or more ingress channels 110(0)-110(C) of FIG. 1) and one or more egress channels (such as the one or more egress channels 112(0)-112(E) of FIG. 1) into a plurality of groups (e.g., the plurality of groups 300(0), 300(1) of FIGS. 3A-3B) each comprising at least one ingress channel (such as the ingress channel 110(0) of FIG. 1) and at least one egress channel (e.g., the egress channel 112(0) of FIG. 1) (block 602). The data allocation circuit 106 in such embodiments assigns, to each group of the plurality of groups 300(0), 300(1), a corresponding unique group priority (such as the group priorities 306(0), 306(1) of FIGS. 3A-3B) (block 604).

Some such embodiments may provide that the operations of block 604 for assigning the group priorities 306(0), 306(1) may comprise the data allocation circuit 106 assigning, to each group of the plurality of groups 300(0), 300(1), a corresponding individual priority (e.g., the individual priorities 302(0), 302(1) of FIGS. 3A-3B) as a unique value between zero (0) and Z−1 inclusive, wherein Z is an integer representing a count of the plurality of groups 300(0), 300(1) (block 606). The data allocation circuit 106 next determines a group offset (such as the group offset 304 of FIGS. 3A-3B) as an integer that is larger than a largest count of the ingress channels 110(0)-110(C) in each group of the plurality of groups 300(0), 300(1), and that can be evenly divided by the largest count of ingress channels 110(0)-110(C) in each group of the plurality of groups 300(0), 300(1) (block 608). The data allocation circuit 106 then assigns, to each group of the plurality of groups 300(0), 300(1), the corresponding unique group priority 306(0), 306(1) as a product of the corresponding individual priority 302(0), 302(1) and the group offset 304 (block 610). The exemplary operations 600 continue at block 612 of FIG. 6B.

Referring now to FIG. 6B, the data allocation circuit 106 assigns a corresponding ingress channel priority (such as the ingress channel priorities 114(0)-114(C) of FIG. 1) to each ingress channel of the one or more ingress channels 110(0)-110(C) communicatively coupled to the data allocation circuit 106 (block 612). In some embodiments, the operations of block 610 for assigning the ingress channel priorities 114(0)-114(C) may comprise the data allocation circuit 106 assigning the corresponding ingress channel priority 114(0)-114(C) to each ingress channel of the one or more ingress channels 110(0)-110(C) as a unique value between zero (0) and X−1 inclusive, wherein X is an integer representing a count of the one or more ingress channels 110(0)-110(C), and zero (0) represents a highest ingress channel priority 114(0)-114(C) (block 614). The data allocation circuit 106 also assigns a corresponding egress channel priority (such as the egress channel priorities 116(0)-116(E) of FIG. 1) to each egress channel of the one or more egress channels 112(0)-112(E) communicatively coupled to the data allocation circuit 106 (block 616). Some embodiments may provide that the operations of block 616 for assigning the egress channel priorities 116(0)-116(E) comprise the data allocation circuit 106 assigning the corresponding egress channel priority 116(0)-116(E) to each egress channel of the one or more egress channels 112(0)-112(E) as a unique value between zero (0) and Y−1 inclusive, wherein Y is an integer representing a count of the one or more egress channels 112(0)-112(E); and zero (0) represents a highest egress channel priority 116(0)-116(E) (block 618). The exemplary operations 600 continue at block 620 of FIG. 6C.

With reference now to FIG. 6C, the data allocation circuit 106 generates one or more channel pairs (e.g., the channel pairs 118(0)-118(P) of FIG. 1) by performing a series of operations iteratively (block 620). The data allocation circuit 106 identifies an unpaired egress channel (such as the egress channel 112(0) of FIG. 1) having a highest egress channel priority 116(0)-116(E) among the one or more egress channels 112(0)-112(E) (block 622). Some embodiments may provide that the operations of block 622 for identifying the unpaired egress channel 112(0) having the highest egress channel priority 116(0)-116(E) may comprise the data allocation circuit 106 identifying an unpaired egress channel 112(0) having a highest combination priority of a group priority 306(0) and the egress channel priority 116(0) of the egress channel 112(0) among the one or more egress channels 112(0)-112(E) (block 624).

According to some embodiments, the data allocation circuit 106 may determine whether a target mode condition (e.g., the target mode condition 500(0) of FIG. 5) for an ingress channel 110(0) of the one or more ingress channels 110(0)-110(C) is met (block 626). In such embodiments, if the data allocation circuit 106 determines at decision block 626 that the target mode condition 500(0) is met, the data allocation circuit 106 allocates the unpaired egress channel 112(0) to the ingress channel 110(0) for which the target mode condition 500(0) is met as a channel pair (such as the channel pair 118(0) of FIG. 1) (block 628). The exemplary operations 600 in such embodiments continue at block 630 of FIG. 6D. In embodiments in which the operations of decision block 626 are not performed and/or embodiments in which the data allocation circuit 106 determines at decision block 626 that the target mode condition 500(0) is not met, the exemplary operations 600 continue at block 632 of FIG. 6D.

Turning now to FIG. 6D, the operations performed iteratively by the data allocation circuit 106 to generate the one or more channel pairs 118(0)-118(P) continue (block 620). If the data allocation circuit 106 determines at decision block 626 of FIG. 6D that the target mode condition 500(0) is not met or does not perform the operations of block 626, the data allocation circuit 106 calculates one or more absolute differences (such as the absolute differences 120(0)-120(C) of FIG. 1) between an ingress channel priority 114(0)-114(C) of each unpaired ingress channel of the one or more ingress channels 110(0)-110(C) and the egress channel priority (e.g., the egress channel priority 116(0) of FIG. 1) of the unpaired egress channel 112(0) (block 632). In embodiments in which the ingress channels 110(0)-110(C) and the egress channels 112(0)-112(E) are organized into the groups 300(0), 300(1), the operations of block 632 for calculating the absolute differences 120(0)-120(C) may comprise the data allocation circuit 106 calculating one or more absolute differences 120(0)-120(C) between a sum of an ingress channel priority 114(0)-114(C) of each unpaired ingress channel of the one or more ingress channels 110(0)-110(C) and a group priority 306(0), 306(1) of each unpaired ingress channel, and a sum of the egress channel priority 116(0) of the unpaired egress channel 112(0) and the group priority 306(0) of the unpaired egress channel 112(0) (block 634). Some embodiments may provide that each of the unpaired ingress channel is in a same group as the unpaired egress channel 112(0).

The data allocation circuit 106 next allocates the unpaired egress channel 112(0) to an unpaired ingress channel (e.g., the ingress channel 110(0) of FIG. 1) that corresponds to the smallest absolute difference (such as the absolute difference 120(0) of FIG. 1) of the one or more absolute differences 120(0)-120(C) as a channel pair (e.g., the channel pair 118(0) of FIG. 1) (block 636). The data allocation circuit 106 then performs one or more transactions (such as the transactions 124(0)-124(P) of FIG. 1) using the corresponding one or more channel pairs 118(0)-118(P) (block 630). The exemplary operations 600 in embodiments in which the ingress channels 110(0)-110(C) and the egress channels 112(0)-112(E) are organized into the groups 300(0), 300(1) may continue at block 638 of FIG. 6E, while the exemplary operations 600 in embodiments in which the groups 300(0), 300(1) are not employed may continue at block 642 of FIG. 6E.

Referring now to FIG. 6E, in embodiments in which the ingress channels 110(0)-110(C) and the egress channels 112(0)-112(E) are organized into the groups 300(0), 300(1), the data allocation circuit 106 may update the individual priority 302(0), 302(1) of each group of the plurality of groups 300(0), 300(1) as a remainder of a sum of the individual priority 302(0), 302(1) of the group and a count of the one or more transactions 314(0)-314(E), divided by Z (block 638). The data allocation circuit 106 may also update the group priority 306(0), 306(1) of each group of the plurality of groups 300(0), 300(1) as a product of the individual priority 302(0), 302(1) of the group and the group offset 304) (block 640).

The data allocation circuit 106 in some embodiments updates the ingress channel priority 114(0)-114(C) of each ingress channel of the one or more ingress channels 110(0)-110(C) as a remainder of a sum of the ingress channel priority 114(0)-114(C) and a count of the one or more transactions 124(0)-124(P) divided by X (block 642). The data allocation circuit 106 in such embodiments also updates the egress channel priority 116(0)-116(E) of each egress channel of the one or more egress channels 112(0)-112(E) as a sum of one (1) and a remainder of a sum of the egress channel priority 116(0)-116(E) and the count of the one or more transactions 124(0)-124(P) divided by Y (block 644).

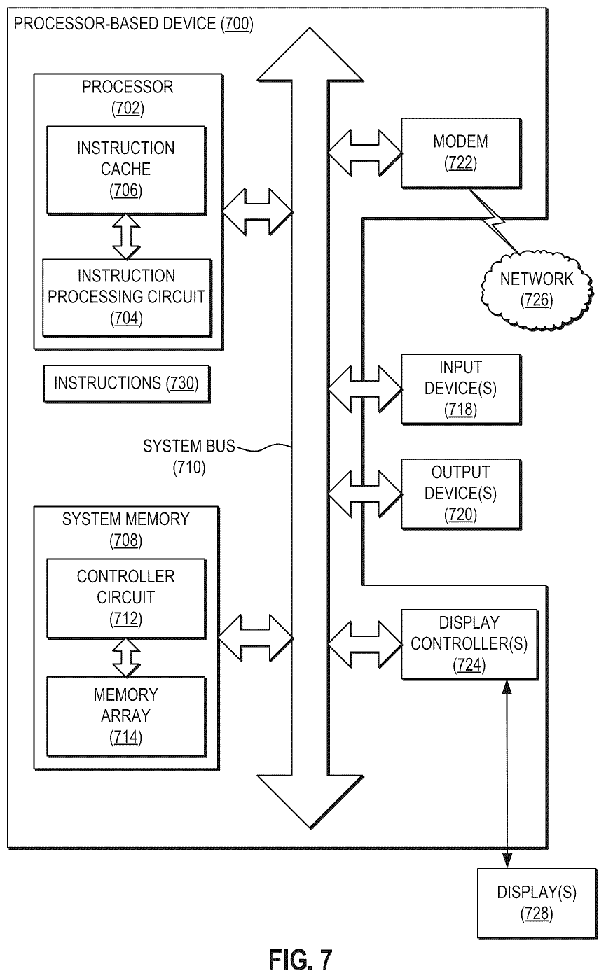

FIG. 7 is a block diagram of an exemplary processor-based device 700 that includes a processor 702 (e.g., a microprocessor) that includes an instruction processing circuit 704. The processor-based device 700 can be the processor-based device 100 in FIG. 1 as an example. The processor-based device 700 may be a circuit or circuits included in an electronic board card, such as a printed circuit board (PCB), a server, a personal computer, a desktop computer, a laptop computer, a personal digital assistant (PDA), a computing pad, a mobile device, or any other device, and may represent, for example, a server, or a user's computer.

In this example, the processor 702 represents one or more general-purpose processing circuits, such as a microprocessor, central processing unit, or the like. The processor 702 is configured to execute processing logic in instructions for performing the operations and steps discussed herein. In this example, the processor 702 includes an instruction cache 706 for temporary, fast access memory storage of instructions accessible by the instruction processing circuit 704. Fetched or prefetched instructions from a memory, such as from the system memory 708 over a system bus 710, are stored in the instruction cache 706. The instruction processing circuit 704 is configured to process instructions fetched into the instruction cache 706 and process the instructions for execution.

The processor 702 and the system memory 708 are coupled to the system bus 710 and can intercouple peripheral devices included in the processor-based device 700. As is well known, the processor 702 communicates with these other devices by exchanging address, control, and data information over the system bus 710. For example, the processor 702 can communicate bus transaction requests to a controller circuit 712 in the system memory 708 as an example of a subordinate device. Although not illustrated in FIG. 7, multiple system buses 710 could be provided, wherein each system bus constitutes a different fabric. In this example, the controller circuit 712 is configured to provide memory access requests to a memory array 714 in the system memory 708, and corresponds in functionality to the data allocation circuit 106 of FIG. 1. The memory array 714 is comprised of an array of storage bit cells for storing data. The system memory 708 may be a read-only memory (ROM), flash memory, dynamic random access memory (DRAM), such as synchronous DRAM (SDRAM), etc., and a static memory (e.g., flash memory, static random access memory (SRAM), etc.), as non-limiting examples.

Other devices can be connected to the system bus 710. As illustrated in FIG. 7, these devices can include the system memory 708, one or more input device(s) 718, one or more output device(s) 720, a modem 722, and one or more display controllers 724, as examples. The input device(s) 718 can include any type of input device, including but not limited to input keys, switches, voice processors, etc. The output device(s) 720 can include any type of output device, including but not limited to audio, video, other visual indicators, etc. The modem 722 can be any device configured to allow exchange of data to and from a network 726. The network 726 can be any type of network, including but not limited to a wired or wireless network, a private or public network, a local area network (LAN), a wireless local area network (WLAN), a wide area network (WAN), a BLUETOOTH™ network, and the Internet. The modem 722 can be configured to support any type of communications protocol desired. The processor 702 may also be configured to access the display controller(s) 724 over the system bus 710 to control information sent to one or more displays 728. The display(s) 728 can include any type of display, including but not limited to a cathode ray tube (CRT), a liquid crystal display (LCD), a plasma display, etc.

The processor-based device 700 in FIG. 7 may include a set of instructions 730 to be executed by the processor 702 for any application desired according to the instructions. The instructions 730 may be stored in the system memory 708, processor 702, and/or instruction cache 706 as examples of a non-transitory computer-readable medium. The instructions 730 may also reside, completely or at least partially, within the system memory 708 and/or within the processor 702 during their execution. The instructions 730 may further be transmitted or received over the network 726 via the modem 722.

While the computer-readable medium is described herein in an exemplary embodiment to be a single medium, the term “computer-readable medium” should be taken to include a single medium or multiple media (e.g., a centralized or distributed database, and/or associated caches and servers) that stores the one or more sets of instructions. The term “computer-readable medium” shall also be taken to include any medium that is capable of storing, encoding, or carrying a set of instructions for execution by the processing device and that causes the processing device to perform any one or more of the methodologies of the embodiments disclosed herein. The term “computer-readable medium” shall accordingly be taken to include, but not be limited to, solid-state memories, optical medium, and magnetic medium.

The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software process.

The embodiments disclosed herein may be provided as a computer program product, or software process, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes: a machine-readable storage medium (e.g., ROM, random access memory (“RAM”), a magnetic disk storage medium, an optical storage medium, flash memory devices, etc.), and the like.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components of the processor-based devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA), or other programmable logic device, a discrete gate or transistor logic, discrete hardware components, or any combination thereof designed to perform the functions described herein. Furthermore, a controller may be a processor. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The embodiments disclosed herein may be embodied in hardware and in instructions that are stored in hardware, and may reside, for example, in RAM, flash memory, ROM, Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be references throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A processor-based device, comprising a data allocation circuit communicatively coupled to one or more ingress channels and one or more egress channels;
the data allocation circuit configured to:
assign, to each ingress channel of the one or more ingress channels, a corresponding ingress channel priority;
assign, to each egress channel of the one or more egress channels, a corresponding egress channel priority;
generate one or more channel pairs by being configured to iteratively:
identify an unpaired egress channel having a highest egress channel priority among the one or more egress channels;
calculate one or more absolute differences between an ingress channel priority of each unpaired ingress channel of the one or more ingress channels and the egress channel priority of the unpaired egress channel; and
allocate the unpaired egress channel to an unpaired ingress channel that corresponds to a smallest absolute difference of the one or more absolute differences as a channel pair; and
perform one or more transactions using the corresponding one or more channel pairs.

2. The processor-based device of claim 1, wherein:
the data allocation circuit is configured to assign, to each ingress channel of the one or more ingress channels, the corresponding ingress channel priority as a unique value between zero (0) and X−1 inclusive, wherein:
X is an integer representing a count of the one or more ingress channels; and
zero (0) represents a highest ingress channel priority; and
the data allocation circuit is configured to assign, to each egress channel of the one or more egress channels, the corresponding egress channel priority as a unique value between zero (0) and Y−1 inclusive, wherein:
Y is an integer representing a count of the one or more egress channels; and
zero (0) represents a highest egress channel priority.

3. The processor-based device of claim 2, wherein the data allocation circuit is further configured to, subsequent to performing the one or more transactions:
update the ingress channel priority of each ingress channel of the one or more ingress channels as a remainder of a sum of the ingress channel priority and a count of the one or more transactions divided by X; and
update the egress channel priority of each egress channel of the one or more egress channels as a sum of one (1) and a remainder of a sum of the egress channel priority and the count of the one or more transactions divided by Y.

4. The processor-based device of claim 1, wherein:
the data allocation circuit is further configured to:
organize the one or more ingress channels and the one or more egress channels into a plurality of groups each comprising at least one ingress channel and at least one egress channel; and
assign, to each group of the plurality of groups, a corresponding unique group priority; and
the data allocation circuit is configured to:
identify the unpaired egress channel having the highest egress channel priority among the one or more egress channels by being configured to identify an unpaired egress channel having a highest combination priority of a group priority and the egress channel priority of the egress channel among the one or more egress channels; and
calculate the one or more absolute differences between the ingress channel priority of each unpaired ingress channel of the one or more ingress channels and the egress channel priority of the unpaired egress channel by being configured to calculate one or more absolute differences between a sum of an ingress channel priority of each unpaired ingress channel of the one or more ingress channels and a group priority of each unpaired ingress channel, and a sum of the egress channel priority of the unpaired egress channel and the group priority of the unpaired egress channel.

5. The processor-based device of claim 4, wherein each unpaired ingress channel is in a same group as the unpaired egress channel.

6. The processor-based device of claim 4, wherein the data allocation circuit is configured to assign, to each group of the plurality of groups, the corresponding unique group priority by being configured to:
assign, to each group of the plurality of groups, a corresponding individual priority as a unique value between zero (0) and Z−1 inclusive, wherein Z is an integer representing a count of the plurality of groups;
determine a group offset as an integer that is larger than a largest count of ingress channels in each group of the plurality of groups, and that can be evenly divided by the largest count of ingress channels in each group of the plurality of groups; and
assign, to each group of the plurality of groups, the corresponding unique group priority as a product of the corresponding individual priority and the group offset.

7. The processor-based device of claim 6, wherein the data allocation circuit is further configured to, subsequent to performing the one or more transactions:
update the individual priority of each group of the plurality of groups as a remainder of a sum of the individual priority of the group and a count of the one or more transactions, divided by Z; and
update the group priority of each group of the plurality of groups as a product of the individual priority of the group and the group offset.

8. The processor-based device of claim 1, wherein:
the data allocation circuit is further configured to, prior to calculating the one or more absolute differences:
determine whether a target mode condition for an ingress channel of the one or more ingress channels is met; and
responsive to determining that the target mode condition is met, allocate the unpaired egress channel to the ingress channel for which the target mode condition is met as the channel pair; and
the data allocation circuit is configured to calculate the one or more absolute differences and allocate the unpaired egress channel to the unpaired ingress channel that corresponds to the smallest absolute difference of the one or more absolute differences as the channel pair responsive to determining that the target mode condition is not met.

9. A method for providing arbitration for resource sharing using channel priority differences, comprising:
assigning, by a data allocation circuit of a processor-based device, a corresponding ingress channel priority to each ingress channel of one or more ingress channels communicatively coupled to the data allocation circuit;
assigning, by the data allocation circuit, a corresponding egress channel priority to each egress channel of one or more egress channels communicatively coupled to the data allocation circuit;
generating, by the data allocation circuit, one or more channel pairs by iteratively:
identifying an unpaired egress channel having a highest egress channel priority among the one or more egress channels;
calculating one or more absolute differences between an ingress channel priority of each unpaired ingress channel of the one or more ingress channels and the egress channel priority of the unpaired egress channel; and
allocating the unpaired egress channel to an unpaired ingress channel that corresponds to a smallest absolute difference of the one or more absolute differences as a channel pair; and
performing one or more transactions using the corresponding one or more channel pairs.

10. The method of claim 9, comprising:
assigning the corresponding ingress channel priority to each ingress channel of the one or more ingress channels as a unique value between zero (0) and X−1 inclusive, wherein:
X is an integer representing a count of the one or more ingress channels; and
zero (0) represents a highest ingress channel priority; and
assigning the corresponding egress channel priority to each egress channel of the one or more egress channels as a unique value between zero (0) and Y−1 inclusive, wherein:
Y is an integer representing a count of the one or more egress channels; and
zero (0) represents a highest egress channel priority.

11. The method of claim 10, further comprising, subsequent to performing the one or more transactions:
updating the ingress channel priority of each ingress channel of the one or more ingress channels as a remainder of a sum of the ingress channel priority and a count of the one or more transactions divided by X; and
updating the egress channel priority of each egress channel of the one or more egress channels as a sum of one (1) and a remainder of a sum of the egress channel priority and the count of the one or more transactions divided by Y.

12. The method of claim 9, wherein:
the method further comprises:
organizing the one or more ingress channels and the one or more egress channels into a plurality of groups each comprising at least one ingress channel and at least one egress channel; and
assigning, to each group of the plurality of groups, a corresponding unique group priority; and
the method comprises:
identifying the unpaired egress channel having the highest egress channel priority among the one or more egress channels by identifying an unpaired egress channel having a highest combination priority of a group priority and the egress channel priority of the egress channel among the one or more egress channels; and
calculating the one or more absolute differences between the ingress channel priority of each unpaired ingress channel of the one or more ingress channels and the egress channel priority of the unpaired egress channel by calculating one or more absolute differences between a sum of an ingress channel priority of each unpaired ingress channel of the one or more ingress channels and a group priority of each unpaired ingress channel, and a sum of the egress channel priority of the unpaired egress channel and the group priority of the unpaired egress channel.

13. The method of claim 12, wherein each unpaired ingress channel is in a same group as the unpaired egress channel.

14. The method of claim 12, wherein assigning, to each group of the plurality of groups, the corresponding unique group priority comprises:
assigning, to each group of the plurality of groups, a corresponding individual priority as a unique value between zero (0) and Z−1 inclusive, wherein Z is an integer representing a count of the plurality of groups;
determining a group offset as an integer that is larger than a largest count of ingress channels in each group of the plurality of groups, and that can be evenly divided by the largest count of ingress channels in each group of the plurality of groups; and
assigning, to each group of the plurality of groups, the corresponding unique group priority as a product of the corresponding individual priority and the group offset.

15. The method of claim 14, further comprising, subsequent to performing the one or more transactions:
updating the individual priority of each group of the plurality of groups as a remainder of a sum of the individual priority of the group and a count of the one or more transactions, divided by Z; and
updating the group priority of each group of the plurality of groups as a product of the individual priority of the group and the group offset.

16. The method of claim 9, further comprising, prior to calculating the one or more absolute differences, determining that a target mode condition for an ingress channel of the one or more ingress channels is not met; and
the method comprising calculating the one or more absolute differences and allocating the unpaired egress channel to the unpaired ingress channel that corresponds to the smallest absolute difference of the one or more absolute differences as the channel pair responsive to determining that the target mode condition is not met.

17. A non-transitory computer-readable medium, having stored thereon computer-executable instructions that, when executed by a processor device, cause the processor device to:
assign, to each ingress channel of one or more ingress channels, a corresponding ingress channel priority;
assign, to each egress channel of one or more egress channels, a corresponding egress channel priority;
generate one or more channel pairs by causing the processor device to iteratively:
identify an unpaired egress channel having a highest egress channel priority among the one or more egress channels;
calculate one or more absolute differences between an ingress channel priority of each unpaired ingress channel of the one or more ingress channels and the egress channel priority of the unpaired egress channel; and
allocate the unpaired egress channel to an unpaired ingress channel that corresponds to a smallest absolute difference of the one or more absolute differences as a channel pair; and
perform one or more transactions using the corresponding one or more channel pairs.

18. The non-transitory computer-readable medium of claim 17, wherein:
the computer-executable instructions cause the processor device to assign, to each ingress channel of the one or more ingress channels, the corresponding ingress channel priority as a unique value between zero (0) and X−1 inclusive, wherein:
X is an integer representing a count of the one or more ingress channels; and
zero (0) represents a highest ingress channel priority; and
the computer-executable instructions cause the processor device to assign, to each egress channel of the one or more egress channels, the corresponding egress channel priority as a unique value between zero (0) and Y−1 inclusive, wherein:
Y is an integer representing a count of the one or more egress channels; and
zero (0) represents a highest egress channel priority.

19. The non-transitory computer-readable medium of claim 17, wherein:
the computer-executable instructions further cause the processor device to:
organize the one or more ingress channels and the one or more egress channels into a plurality of groups each comprising at least one ingress channel and at least one egress channel; and
assign, to each group of the plurality of groups, a corresponding unique group priority; and
the computer-executable instructions cause the processor device to:
identify the unpaired egress channel having the highest egress channel priority among the one or more egress channels by causing the processor device to identify an unpaired egress channel having a highest combination priority of a group priority and the egress channel priority of the egress channel among the one or more egress channels; and
calculate the one or more absolute differences between the ingress channel priority of each unpaired ingress channel of the one or more ingress channels and the egress channel priority of the unpaired egress channel by causing the processor device to calculate one or more absolute differences between a sum of an ingress channel priority of each unpaired ingress channel of the one or more ingress channels and a group priority of each unpaired ingress channel, and a sum of the egress channel priority of the unpaired egress channel and the group priority of the unpaired egress channel.

20. The non-transitory computer-readable medium of claim 17, wherein:
the computer-executable instructions further cause the processor device to, prior to calculating the one or more absolute differences:
determine whether a target mode condition for an ingress channel of the one or more ingress channels is met; and
responsive to determining that the target mode condition is met, allocate the unpaired egress channel to the ingress channel for which the target mode condition is met as the channel pair; and
the computer-executable instructions cause the processor device to calculate the one or more absolute differences and allocate the unpaired egress channel to the unpaired ingress channel that corresponds to the smallest absolute difference of the one or more absolute differences as the channel pair responsive to determining that the target mode condition is not met.
